(19) United States
(12) Patent Application Publication
(10) Pub. No.: US 2019/0003244 A1
(43) Pub. Date: Jan. 3, 2019

(54) NO-CHAMBER GAS FILLING FOR AN INSULATED GLASS UNIT

(71) Applicant: PDS IG Holding LLC, Prairie Du Sac, WI (US)

(72) Inventor: Paul Trpkovski, Kailua Kona, HI (US)

(21) Appl. No.: 16/024,778

(22) Filed: Jun. 30, 2018

Related U.S. Application Data
(60) Provisional application No. 62/528,083, filed on Jul. 1, 2017.

(51) Int. Cl. E06B 3/677; E06B 3/66

(52) U.S. Cl. CPC E06B 3/6775; E06B 3/6612

(57) ABSTRACT

A method for filling an unsealed insulating glass unit (IGU) includes providing an IGU assembly on a support structure and between a first plate and a second plate. The unsealed IGU assembly has a spacer frame between first and second sheets, thus defining an interpane space and an IGU passage that provides fluid communication between the interpane space and an ambient environment. The method also includes pressing the unsealed IGU assembly against the second plate with the first plate while pulling a first vacuum on the first sheet with the first plate and pulling a second vacuum on the second sheet with the second plate. The method also includes evacuating air from the interpane space through the IGU passage and introducing a gas into the interpane space through the IGU passage. A gas filling system having similar attributes is also provided.

### CROSS-REFERENCE TO RELATED APPLICATIONS

This application claims the benefit of U.S. Provisional Application No. 62/528,083, filed Jul. 1, 2017, the content of which is herein incorporated by reference in its entirety.

This application is related to U.S. Ser. No. 62/528,082, filed Jul. 1, 2017, and to a nonprovisional application claiming priority therefrom, having the title “Gas Filling Assembly Machine and Method for an Insulated Glass Unit,” having attorney docket number 824.0011USU1, and being filed on Jun. 30, 2018, the even date herewith (hereinafter “the '11 application”). The contents of U.S. 62/528,082 and the '11 application are incorporated herein by reference in their entireties.

This application is also related to U.S. Ser. No. 62/528,089, filed Jul. 1, 2017, and to a nonprovisional application claiming priority therefrom, having the title “Filling and Sealing Device and Method for an Insulated Glass Unit,” having attorney docket number 824.0013USU1, and being filed on Jun. 30, 2018, the even date herewith (hereinafter “the '13 application”). The contents of U.S. 62/528,089 and the '13 application are incorporated herein by reference in their entireties.

This application is also related to U.S. application Ser. No. 15/640,512, filed on Jul. 1, 2017 (now U.S. Publ. No. 2017/0299121), which is a continuation-in-part of prior U.S. application Ser. No. 15/398,459, filed Jan. 4, 2017, which claims the benefit of U.S. Provisional Application No. 62/274,676, filed Jan. 4, 2016, each of the contents of which are herein incorporated by reference in their entireties.

### FIELD OF THE TECHNOLOGY

The present application relates to filling an insulating glass unit with a gas. More specifically, the present application relates to evacuating and filling an interpane space of an insulating glass unit with a gas.

### BACKGROUND

In recent years, there has been an increased awareness of energy usage and conservation. As a result many governing bodies have released energy standards and regulations for buildings and construction materials. These standards and regulations frequently require more energy efficient systems and components.

One specific area of focus includes more efficient windows and doors. Many governing bodies have passed regulations that require windows and doors to have a minimum insulating value to limit the amount of energy lost through windows and doors. As a result, window and door manufacturers have needed to find ways to increase the insulating properties of their products. The materials and techniques used to produce more insulated windows and doors have resulted in an increased cost to manufacture the windows and doors.

Some techniques and systems have been developed to fill glass units with one or more insulating gases. For example, U.S. Pat. No. 8,627,856 discloses a method and apparatus wherein the insulating gases are supplied to gas filling tubes that are inserted into one or more interpane spaces of the insulating glass units. Each interpane space may be filled with more than one insulating gas. A control unit controls the injection of the insulating gases in accordance with gas filling data received by the control unit.

### SUMMARY

One general aspect includes a method for filling an insulating glass unit (IGU) with a gas, including: providing an unsealed IGU assembly on a support structure and between a first plate and a second plate, the unsealed IGU assembly including a first sheet, a second sheet, and a spacer frame between the first sheet and the second sheet, the unsealed IGU assembly defining an interpane space between the first sheet and the second sheet and an IGU passage providing fluid communication between the interpane space and an ambient environment. The method also includes pressing the unsealed IGU assembly against the second plate with the first plate while pulling a first vacuum on the first sheet with the first plate and pulling a second vacuum on the second sheet with the second plate. The method also includes evacuating air from the interpane space through the IGU passage. The method also includes introducing a gas into the interpane space through the IGU passage.

Implementations may include one or more of the following features. The method where the ambient environment has an air pressure approximately equal to atmospheric pressure while evacuating the air from the interpane space and introducing the gas into the interpane space. The method where pulling the first vacuum with the first plate includes evacuating air through openings in the first plate and where pulling the second vacuum with the second plate includes evacuating air through openings in the second plate. The method where providing the unsealed IGU assembly on the support structure between the first plate and the second plate includes forming the unsealed IGU assembly at an assembly stage and then moving the unsealed IGU assembly onto the support structure and into the space between the first plate and the second plate. The method further including closing the IGU passage to seal the interpane space while the unsealed IGU assembly is on the support structure. The method where providing the unsealed IGU assembly on the support structure between the first plate and the second plate includes: moving the first sheet to be on the support structure and between the first plate and the second plate. The method may also include moving the first sheet away from the support structure with the first plate. The method may also include moving an IGU subassembly to be on the support structure and between the first sheet and the second plate. The method may also include moving the first sheet with the first plate to be next to the IGU subassembly to form the unsealed IGU assembly. The method where evacuating the air from the interpane space includes automatically actuating a fluid handling device to be in fluid communication with the IGU passage and evacuating the air through a fluid passage of the fluid handling device. The method where the IGU passage includes a hole in the spacer frame. The method where introducing the gas into the interpane space includes, after evacuating the air from the interpane space, introducing the gas into the interpane space through the fluid passage of the fluid handling device. The method where the unsealed IGU assembly further includes an intermediate pane of transparent or translucent material located between the first and second sheets, where the intermediate pane defines an opening to permit fluid communication between a first portion of the interpane space adjacent to the first sheet and a second portion of the interpane space adjacent to the second sheet.

One general aspect includes a method for filling an insulating glass unit (IGU), including: moving a first sheet to be on a support structure and between a first vacuum platen and a second vacuum platen. The method also includes moving the first sheet away from the support structure with the first vacuum platen. The method also includes moving an IGU subassembly to be on the support structure and between the first sheet and the second vacuum platen, the IGU subassembly including a spacer frame and a second sheet. The method also includes moving the first sheet next to the IGU subassembly with the first vacuum platen, and at least partially sealing the first sheet to the IGU subassembly, thereby forming an unsealed IGU assembly defining an interpane space between the first sheet and the second sheet and an IGU passage providing fluid communication between the interpane space and an ambient environment. The method also includes after forming the unsealed IGU assembly, pulling a first vacuum on the first sheet with the first vacuum platen and pulling a second vacuum on the second sheet with the second vacuum platen. The method also includes while pulling the first vacuum on the first sheet and the second vacuum on the second sheet, pressing the unsealed IGU assembly against the second vacuum platen with the first vacuum platen, evacuating air from the interpane space through the IGU passage, and introducing a gas into the interpane space through the IGU passage.

Implementations may include one or more of the following features. The method where the ambient environment has an air pressure approximately equal to atmospheric pressure while evacuating the air from the interpane space and introducing the gas into the interpane space. The method where evacuating the air from the interpane space includes automatically actuating a fluid handling device to be in fluid communication with the IGU passage and evacuating the air through a fluid passage of the fluid handling device. The method where the IGU passage includes a hole in the spacer frame. The method where introducing the gas into the interpane space includes, after evacuating the air from the interpane space, introducing the gas into the interpane space through the fluid passage of the fluid handling device. The method where the unsealed IGU assembly further includes an intermediate pane of transparent or translucent material located between the first and second sheets, where the intermediate pane defines an opening to permit fluid communication between a first portion of the interpane space adjacent to the first sheet and a second portion of the interpane space adjacent to the second sheet.

One general aspect includes a system for gas filling of an insulated glass unit (IGU), the system including: a support structure configured to support an unsealed IGU assembly during evacuation and filling with a gas, the unsealed IGU assembly including an outer first sheet, an outer second sheet, and a spacer frame between the first sheet and the second sheet, the unsealed IGU assembly defining an interpane space between the first sheet and the second sheet and an IGU passage providing fluid communication between the interpane space and an ambient environment. The system also includes a first plate configured to pull a first vacuum on the first sheet of the unsealed IGU assembly upon the support structure. The system also includes a second plate attached to the support structure and facing the first plate, the second plate configured to pull a second vacuum on the second sheet of the unsealed IGU assembly upon the support structure. The system also includes a fluid handling device configured to be positioned next to the IGU passage of the unsealed IGU assembly upon the support structure for one or more of evacuating the interpane space and filling the interpane space with the gas. The system also includes a vacuum source in selective fluid communication with one or more of the first plate, the second plate, and the fluid handling device. The system also includes a gas supply in selective fluid communication with the fluid handling device. The system also includes where the first plate is configured to simultaneously press the unsealed IGU assembly against the second plate and pull the first vacuum on the first sheet while the second plate pulls the second vacuum on the second sheet, to assist the fluid handling device in evacuating the interpane space of the unsealed IGU assembly while in an ambient environment having an air pressure approximately equal to atmospheric pressure.

Implementations may include one or more of the following features. The system where the first sheet includes a first vacuum platen and the second sheet includes a second vacuum platen. The system where the IGU passage includes a hole in the spacer frame of the unsealed IGU assembly, where the fluid handling device includes a fluid passage in selective fluid communication with the vacuum source, and further including an actuator configured to automatically move the filling device into a first position where the fluid passage is in fluid communication with the IGU passage to evacuate the interpane space. The system where the fluid passage of the fluid handling device is in selective fluid communication with the gas supply for inserting the gas into the interpane space of the unsealed IGU assembly after evacuation. The system where the support structure is configured to receive the first sheet and where the first plate is further configured to pick up the first sheet from the support structure, move the first sheet away from the support structure, and/or place the first sheet back on the support structure next to an IGU subassembly to form the unsealed IGU assembly.

### BRIEF DESCRIPTION OF THE DRAWINGS

The technology may be more completely understood in connection with the drawings, in which:

FIG. 1 is a side schematic view of a system for gas filling an unsealed insulated glass unit (IGU) assembly, according to various embodiments.

FIGS. 2-6 are side schematic views of the system of FIG. 1 illustrating steps for assembling an unsealed IGU, according to various embodiments.

FIG. 7 is a cut away perspective view of the system of FIG. 1 showing an actuator and connected fluid handling device, according to various embodiments.

FIGS. 8-9 are side schematic and cut away perspective views, respectively, of the system of FIG. 7 showing the connected fluid handling device inserted into an unsealed IGU assembly, according to various embodiments.

FIGS. 10-11 are partial front and top schematic views of the system of FIG. 7 showing the actuator and connected fluid handling device, according to various embodiments.

FIGS. 12-13 are partial front and top schematic views of the system of FIG. 8-9 showing the actuator and connected fluid handling device, according to various embodiments.

FIG. 14 is a side schematic view of the system of FIG. 4 showing an IGU after gas filling and sealing, according to various embodiments.

FIG. 15 is a side schematic view of a system for gas filling an unsealed IGU assembly, according to various embodiments.

FIGS. 16-19 are side schematic views of the system of FIG. 15 illustrating steps for assembling an unsealed IGU, according to various embodiments.

FIGS. 20-21 are side schematic views of the system of FIG. 15 showing a fluid handling device, according to various embodiments.

FIG. 22 is a cut away perspective view of the system of FIG. 21, showing the connected fluid handling device inserted into an unsealed IGU assembly, according to various embodiments.

FIGS. 23-24 are partial front and top schematic views of the system of FIG. 21 showing the actuator and connected fluid handling device, according to various embodiments.

FIGS. 25-26 are partial front and top schematic views of the system of FIG. 22 showing the actuator and connected filling device inserted into the unsealed IGU, according to various embodiments.

FIG. 27 is a side schematic view of the system of FIG. 15 showing an IGU after gas filling and sealing, according to various embodiments.

FIG. 28 is a front view of an IGU gas filling system, according to various embodiments.

FIG. 29 is a left end view of the IGU gas filling system shown in FIG. 28, according to various embodiments.

FIG. 30 is a right perspective view of the IGU gas filling system shown in FIG. 28, according to various embodiments.

FIG. 31 is a partial perspective view of a movable plate and a gas filling ram of the IGU gas filling system shown in FIG. 28, according to various embodiments.

FIG. 32 is a perspective view of an insulating glass unit (IGU), according to various embodiments.

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Embodiments described herein relate to methods and machines for manufacturing sealed insulating glass units (IGUs). In various embodiments, an insulating glass unit or IGU includes a first sheet of glass material and a second sheet of glass material. Some insulating glass units can further include a third sheet, such as a sheet of glass material. A spacer can separate the first sheet from the second sheet, and can extend around the insulating glass unit near the perimeter of the insulating glass unit. The first sheet, second sheet, and spacer define an interpane space or volume that can be initially filled with air, such as air from the ambient environment of the manufacturing facility. In various embodiments, the air can be replaced with a different gas, such as to increase or affect the insulating properties of the window. Various different gases have different insulating properties. Some varieties of IGUs have a first sheet, a second sheet, and an intermediate sheet between the first and second sheets and are referred to as triple pane IGUs. In some examples, two portions of an interpane space of a triple pane IGU are in fluid communication with each other through an opening in the intermediate sheet.

Generally speaking, various embodiments described herein include providing and/or positioning one or more components of an IGU on a support structure to form an unsealed IGU assembly. While on the support structure, the unsealed IGU assembly can be evacuated of existing air. According to various embodiments, the unsealed IGU assembly is evacuated without the use of a vacuum chamber, or in some cases at least without evacuating, or lowering the pressure within, a vacuum chamber. In some implementations, the ambient environment surrounding the support structure may have an air pressure approximately equal to atmospheric pressure while an unsealed IGU assembly is evacuated.

According to various embodiments, after evacuating an unsealed IGU assembly, the interpane space of the assembly can be filled with a gas providing one or more desirable features. In some cases the interpane space is filled with a gas without using a vacuum chamber. According to various embodiments, after filling the unsealed IGU assembly with one or more gases, the IGU assembly is then sealed.

In some implementations, the filled IGU assembly is moved to another staging area in order to be sealed. In some implementations, the filled IGU assembly may instead be sealed while on the support structure.

The manufacture of insulating glass units (IGUs) is generally a complex process that can involve large, expensive, and complex pieces of manufacturing equipment. In some cases the need to use multiple pieces of large manufacturing equipment necessitates a larger than desired installation footprint. For example, some IGU manufacturing processes can involve multiple machines and stations, which must be spread out across a plant. The number of pieces of equipment, and their spatial arrangement, can in some cases result in assembly lines that are longer than desired.

In many existing cases, insulating glass units are manufactured using a vacuum chamber, which can be referred to as a vacuum enclosure. While in the reduced pressure environment of the vacuum chamber, existing air is typically drawn out of the unsealed IGU assembly, which is then filled with one or more interpane gases. The reduced air pressure within a vacuum chamber can facilitate evacuating and filling IGU assembly.

According to various embodiments, such as those described herein, methods and systems can enable evacuation and filling of an unsealed IGU assembly without using a vacuum chamber. Evacuating and filling an IGU assembly without a vacuum chamber can provide a more visible manufacturing process not obscured by a sealed vacuum chamber.

Various aspects and features described herein are directed to filling an insulating glass unit (IGU) with one or more gases. According to various embodiments, a method for filling an IGU includes providing an unsealed IGU assembly on a support structure, between a first plate and a second plate. In some implementations, the first plate and the second plate are support plates configured to support a sheet of glass, either alone or as part of an unsealed IGU assembly. The unsealed IGU assembly includes a first sheet, a second sheet, and a spacer frame between the first sheet and the second sheet. An interpane space is defined between the first sheet and the second sheet and the unsealed IGU assembly further defines an IGU passage that provides fluid communication between the interpane space and an ambient environment.

According to this implementation, the method includes using the first plate to press the unsealed IGU assembly against the second plate. At the same time, the first plate pulls a first vacuum on the first sheet of the IGU and the second plate pulls a second vacuum on the opposite second sheet of the IGU. The method further includes evacuating air from the interpane space, through the IGU passage of the unsealed IGU assembly. A gas may also be introduced into the interpane space after evacuation, optionally through the IGU passage. In some cases the method optionally includes closing the IGU passage to seal the interpane space while the IGU assembly is on the support structure.

According to various embodiments, another method for gas filling an IGU includes moving a first sheet to be on a support structure and between a first vacuum platen and a second vacuum platen. In some implementations, the method includes moving the first sheet away from the support structure with the first vacuum platen. An IGU subassembly is moved to be on the support structure and between the first sheet and the second vacuum platen.

As used herein, the term “IGU subassembly” refers to one, two, three, or more assembled components of an IGU. According to various embodiments, an IGU subassembly includes a spacer frame and a second sheet of material. The second sheet, or another intervening sheet, is sealed to spacer frame. The sheet of material is glass in some cases. In some cases an IGU subassembly includes a spacer frame sealed to an intermediate pane, an additional spacer frame sealed to the opposite side of the intermediate pane, and sheet of glass sealed to the additional spacer frame for use in a triple pane IGU.

According to some implementations, the method includes using the first vacuum platen to move the first sheet next to the IGU subassembly, and at least partially sealing the first sheet to the IGU subassembly. This forms an unsealed IGU assembly defining an interpane space between the first sheet and the second sheet and an IGU passage providing fluid communication between the interpane space and an ambient environment.

After forming the unsealed IGU assembly, the method includes pulling a first vacuum on the first sheet with the first vacuum platen and pulling a second vacuum on the second sheet with the second vacuum platen. The following occurs while pulling the first vacuum on the first sheet and the second vacuum on the second sheet: 1) pressing the unsealed IGU assembly against the second vacuum platen with the first vacuum platen; 2) evacuating air from the interpane space through the IGU passage; and 3) introducing a gas into the interpane space through the IGU passage. According to various embodiments, the method may optionally include closing the IGU passage to seal the interpane space while pulling the first and second vacuums.

In some cases a system is provided for filling an IGU with an interpane gas. According to various embodiments, the system does not include a vacuum chamber or enclosure. In some implementations the system may optionally include a vacuum chamber but the interior of the vacuum chamber may not be evacuated during use. According to various embodiments, the system includes a support structure that is configured to support an unsealed IGU assembly during evacuation and filling with a gas. The unsealed IGU assembly has an outer first sheet, an outer second sheet, and a spacer frame between the first sheet and the second sheet. The unsealed IGU assembly also defines an interpane space between the first sheet and the second sheet. An IGU passage provides fluid communication between the interpane space and an ambient environment.

According to this implementation, the system includes a first plate and a second plate. The first plate is configured to pull a first vacuum on the outer first sheet of the unsealed IGU assembly upon the support structure. A second plate is attached to the support structure and faces the first plate. This second plate is configured to pull a second vacuum on the outer second sheet of the unsealed IGU assembly positioned on the support structure.

The system also includes a fluid handling device, a vacuum source, and a gas supply according to some implementations. The fluid handling device is configured to be positioned next to the IGU passage of the unsealed IGU assembly while positioned on the support structure. In some cases the fluid handling device is configured to evacuate the interpane space through the IGU passage. In some cases the fluid handling device is configured to fill the interpane space with a gas through the IGU passage. The vacuum source is in selective fluid communication with one or more of the first plate, the second plate, and the fluid handling device. This enables pulling a vacuum on the first and/or second sheets of the unsealed IGU assembly, and/or pulling a vacuum through the IGU passage to evacuate the interpane space of the IGU assembly. The gas supply is in selective fluid communication with the fluid handling device.

According to various embodiments, the first plate is configured to simultaneously press the unsealed IGU assembly against the second plate and pull the first vacuum on the first sheet. At the same time, the second plate is configured to pull the second vacuum on the second sheet. Pressing the unsealed IGU assembly while pulling the vacuums on each side of the assembly can help secure and stabilize the unsealed IGU assembly. Securing the unsealed IGU assembly in this way can facilitate evacuating the interpane space while in an ambient environment having an air pressure approximately equal to atmospheric pressure.

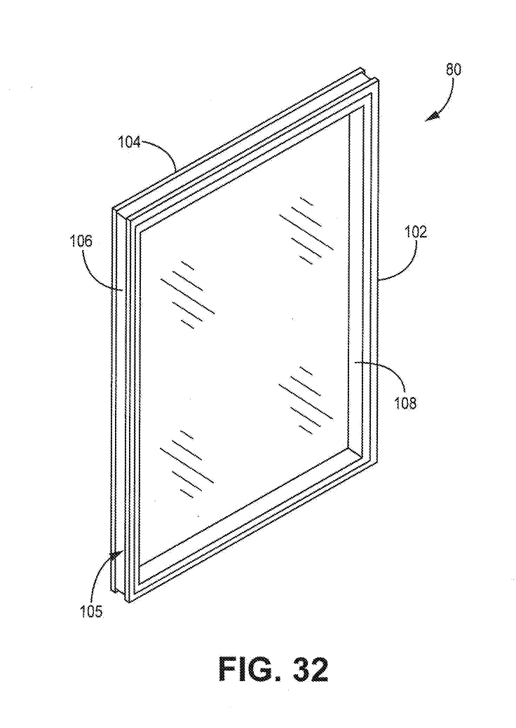

As briefly described above, in some cases an insulating glass unit, or “IGU”, has two or more sheets and a spacer frame. FIG. 32 provides a perspective view of a completed, sealed IGU according to various embodiments. The IGU 80 can include a first sheet 102 and a second sheet 104. In some implementations, the first and second sheets 102, 104, can be referred to as “outer” sheets, since they provide part of the outer boundary of the IGU. In contrast, a sheet positioned between the first and second sheets, such as in the case of a triple-pane IGU, may be referred to as an “intermediate” sheet.

The IGU 80 can include a spacer 106 disposed between the first sheet 102 and the second sheet 104. In various embodiments, the spacer 106 is slightly inset from the perimeter of the first sheet 102 and the second sheet 104. FIG. 32 shows an example of the spacer 106 being inset from the perimeter of the first sheet 102 and the perimeter of the second sheet 104. In various examples, a frame will be added around the perimeter of the IGU 80 prior to the IGU 80 being installed in a building or home.

The first sheet 102 and the second sheet 104 can include a translucent, transparent, or semi-transparent material, such as to allow light to pass through the two sheets 102, 104 or to allow a person to see through the two sheets 102, 104. In various embodiments, the first sheet 102 and the second sheet 104 include a glass material or glass or plastic, such as a clear or translucent glass or plastic. In various embodiments, the first sheet 102 and the second sheet 104 can be similar, such that the two sheets 102, 104 have a substantially similar shape and/or size.

The spacer 106 can be coupled to the first sheet 102 and the second sheet 104. The spacer 106 can extend from the first sheet 102 to the second sheet 104, such as to define a volume or an interpane space 108. The interpane space 108 is defined between the first sheet 102 and the second sheet 104. The spacer 106 also forms a boundary of the interpane space 108.

The spacer 106 is formed into a spacer frame 105 that surrounds the interpane space 108. The spacer frame 105 has a shape that matches the outer perimeter shape of the IGU 80. For example, where the IGU 80 is rectangular as in FIG. 32, the spacer frame 105 is a rectangle. In some embodiments, the spacer frame 105 can be generally rectangular, such as a rectangular shape with rounded corners. In various embodiments, the spacer frame 105 can have rounded corners and the outer perimeter of the IGU can be rectangular with square corners.

In various embodiments, a completed IGU 80 can be sealed, such as to trap an interpane gas within the interpane space 108. The sealed IGU 80 can retain the interpane gas within the interpane space 108 and prevent external gasses from entering the interpane space 108.

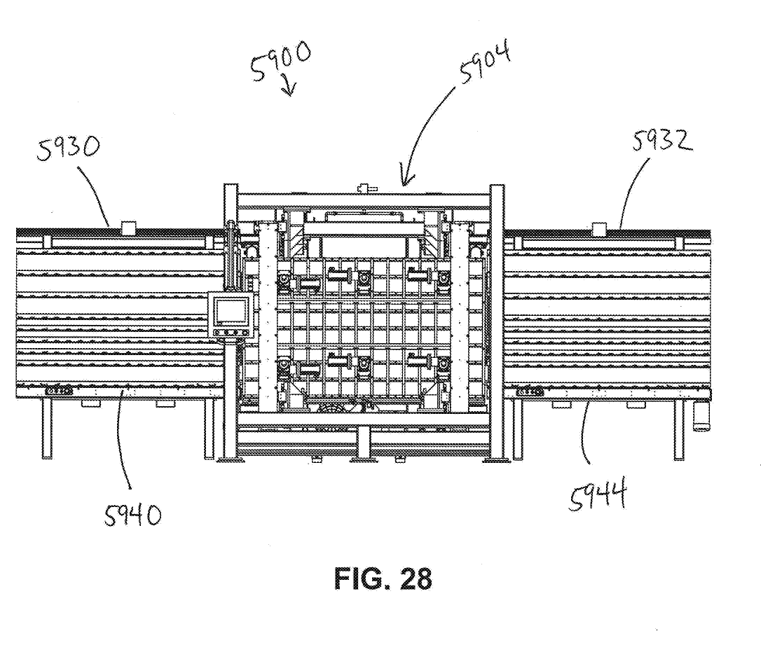

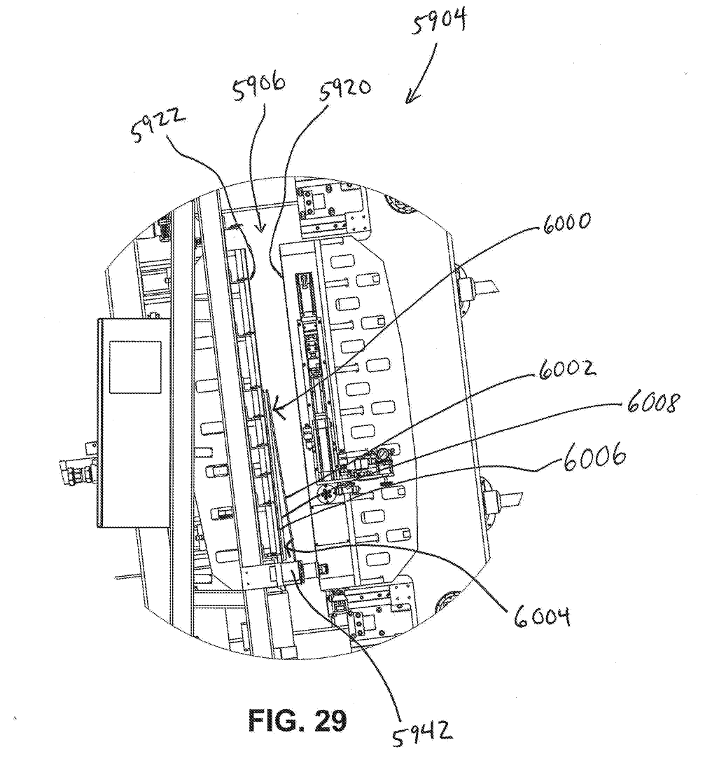

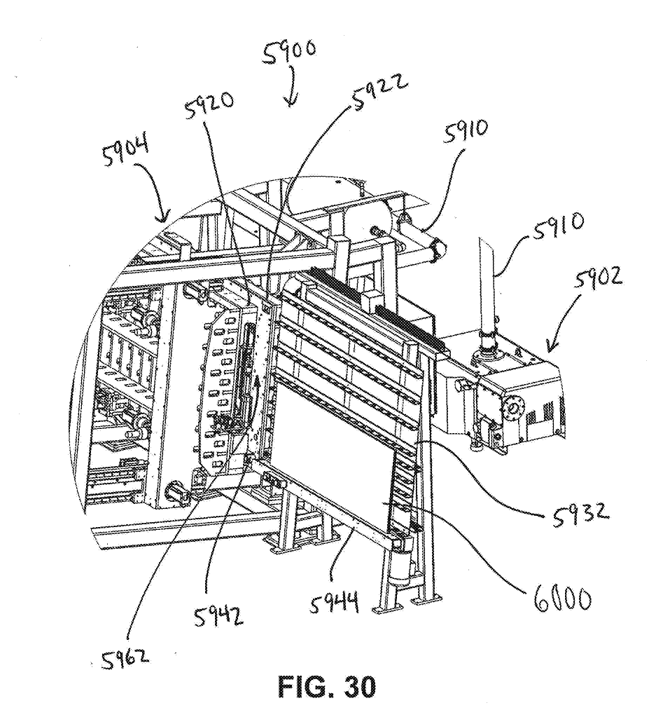

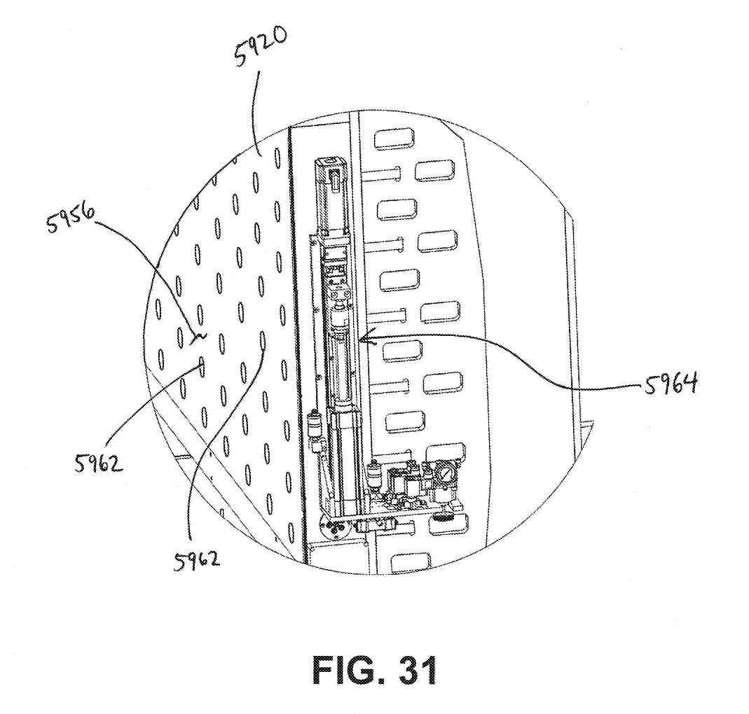

A completed IGU can be manufactured using a gas filling system according to various embodiments described herein. Turning to FIGS. 28-31, parts of an IGU gas filling system 5900 are depicted according to various embodiments. FIG. 28 is a front view of the system, which illustrates the spatial arrangement of some parts. FIG. 29 is a left end view of the system 5900 and FIG. 30 is a perspective view of a right end of the system 5900. FIG. 31 is a partial perspective view of a movable plate 5920 and an attached gas filling ram 5964 that are part of the IGU gas filling system shown in FIG. 28.

According to the illustrated example, the gas filling system 5900 includes a filling stage 5904, which is positioned between a pre-filling staging or assembly structure 5930 and a post-filling structure 5932. Each of the pre- and post-filling areas is configured to move IGU components and/or assemblies into and out of the filling stage 5904, respectively. According to various embodiments, sheets of glass and/or other materials, IGU subassemblies, and/or unsealed IGU assemblies are initially placed on the pre-filling structure 5930.

The pre-filling structure is supported by an actuating mechanism 5940 configured to automatically move components into a loading area 5906 of the filling stage. In various embodiments, the actuating mechanism is a conveyor 5940, such as a belt conveyor. In some cases, such as in the illustrated embodiment, the components are moved into the loading area 5906 using a separate support structure 5942, which can include one, two, or more linear conveyors 5942. In some cases, a single support structure or actuating mechanism, e.g., conveyor, can move IGU components from the pre-filling area 5930, through the filling area 5906, and onto the post-filling area 5932.

FIG. 29 illustrates an example of IGU components that have been translated into the filling stage loading area 5906. In this example, FIG. 29 depicts a tented IGU assembly 6000 within the filling stage 5904. The tented IGU assembly 6000 includes a first sheet 6002 leaning against an IGU subassembly 6004 that is formed from a second sheet and a spacer frame. According to some implementations, the tented IGU assembly 6000 can be assembled (e.g., by hand) at the staging area 5930. The tented IGU assembly 6000 is then moved into the loading area 5906 using the pre-filling stage actuating mechanism 5940. Once inside the loading area 5906 and on the support structure 5942, the tented IGU assembly 6000 can be evacuated and then filled with an interpane gas. After evacuation and filling, the IGU 6000 can be sealed and moved out of the filling stage 5904 to the post-filling structure 5932 using another movable support structure 5944.

According to some implementations, the tented IGU assembly 6000 can be at least partially assembled (e.g., by machine) at the filling stage 5906. In such implementations, IGU components can be separately moved into the filling stage 5904, and then assembled with, for example, the first plate 5920. As an example, in some cases the first plate 5920 is configured to positively engage with a sheet by pulling a vacuum on the sheet. Once engaged, the first plate 5920 can in some cases lift the sheet, move the sheet away from the support structure 5942, and/or position the sheet 6002 on the support structure 5942 with other components to form an IGU assembly. After formation within the filling stage 5906, the tented IGU assembly 6000 can be evacuated and filled, and then sealed and moved out of the filling stage 5904 to the post-filling structure 5932.

Turning back to FIG. 29, the first plate 5920 and an opposing second plate 5922 are depicted. When moved apart, the first and second plates 5920, 5922 define the loading area 5906 between the plates. As shown in the figures, the second plate 5922 is a fixed plate that is attached to the movable support structure 5942 (e.g., conveyor). The first plate 5920 is a movable plate configured to move toward and press an IGU assembly against the second fixed plate 5922, thereby securing the IGU assembly for evacuating and filling.

According to various embodiments, the first plate 5920 can positively engage the first sheet 6002 by pulling a vacuum on the first sheet. As shown in FIG. 31, in some cases the first plate 5920 includes openings or holes 5962 for creating a vacuum between the first plate and a sheet of glass material, such as the first sheet 6002 shown in FIG. 29. Once engaged, the first plate 5920 can in some cases lift the sheet 6002, move the sheet 6002 away from the support structure 5942, and/or position the sheet 6002 on the support structure 5942. As an example, the first plate 5920 can position the first sheet 6002 next to an IGU subassembly 6004 on the support structure 5942 to form an unsealed, tented IGU assembly 6000. According to various embodiments, the first plate 5920 is configured as a vacuum platen that is in selective fluid communication with a vacuum source. As an example, in some implementations the first plate/vacuum platen 5920 is in fluid connection with a vacuum generator or vacuum pump. FIG. 30 illustrates an example of a vacuum generator 5902 and ducting 5910 that can be in selective fluid communication with the first plate 5920 for pulling a vacuum on an outer first sheet of an unsealed IGU assembly supported by the support structure 5942 within the filling stage loading area 5906.

Turning back to FIG. 31, the movable first plate 5920 in this implementation is configured as a press plate. As shown in FIG. 31, the first plate has an extended planar surface 5956 for evenly contacting a sheet of glass or other material. As a press plate, the first plate 5920 is configured to move toward and press the tented IGU assembly 6000 together against the second plate 5922 to form an unsealed IGU assembly. The unsealed IGU assembly has an IGU passage that provides fluid communication into the interpane space of the IGU assembly 6000. After being assembled into an unsealed IGU assembly, a fluid handling device can evacuate the unsealed IGU assembly. In some cases the fluid handling device can fill the evacuated, unsealed IGU assembly with an interpane gas. As an example, FIG. 31 shows an enlarged view of the left side (from the orientation of FIG. 28) of the moveable first plate 5920 and an attached gas supply apparatus 5964 that can be used to fill the IGU assembly with the gas.

As noted above, in various embodiments the first plate 5920 can be used to press an IGU component against the second plate 5922, thus stabilizing and securing the IGU component in the filling stage 5904. According to various embodiments, pressing an unsealed IGU assembly against the second plate can help stabilize and secure the IGU in order to evacuate and fill its interpane space without the use of a vacuum chamber or enclosure. In some implementations, the first plate 5920 and/or the second plate 5922 are configured to pull a vacuum on an outer sheet of a supported IGU assembly to further secure and stabilize the IGU assembly during evacuation and filling without the use of a vacuum chamber. As an example, the openings or holes 5962 in the first plate 5920 can in some cases enable the first plate to pull a vacuum on the first sheet 6002 shown in FIG. 29. In some cases such a vacuum enables the first plate to positively engage the first sheet 6002 to both lift and move the first sheet 6002 upon the support structure 5942 and also to secure the first plate (and other attached components forming the IGU) for evacuation and filling.

Turning to FIG. 30, in various embodiments the second plate 5922 of the system 5904 includes holes or openings 5962 for pulling a vacuum. For example, in some cases the holes 5962 in the second plate enable the second plate 5922 to pull a vacuum on a second sheet 6006 of the IGU assembly 6000. According to various embodiments, pulling this second vacuum helps secure and stabilize the second sheet 6006 and other connected components of the IGU assembly 6000 for evacuating and filling upon the support structure 5942 without the aid of the reduced pressure environment typically provided by a vacuum chamber. In some cases the second plate 5922 pulls the second vacuum in addition to, or as an alternative to, the first sheet 5920 pulling the first vacuum. According to various embodiments, the holes 5962 in the second plate 5922 are in selective fluid communication with a vacuum source, such as the vacuum generator 5902 shown in FIG. 30.

In some implementations, the holes 5962 may also be configured to selectively float a sheet or assembly upon the second plate 5922. For example, in some cases the holes 5962 can be selectively connected with a vacuum source or a gas source. When connected with the gas source, the holes 5962 in the second plate are configured to exhaust the gas (e.g., air), thereby creating a cushion of gas or air to facilitate sheet movement. In some cases creating a cushion of air in this way allows the sheets to “float” on the cushion as they move into and out of the filling stage 5904. When sheets or other assembly components are in a desired position in the filling stage, the cushion of air can be turned off, and the holes can be selectively connected to the vacuum source to pull a vacuum on the sheets or other components.

Continuing with reference to FIG. 30, the system 5900 further includes one or more vacuum sources configured to evacuate an interpane space of an unsealed IGU assembly and/or pull a vacuum on one or more outer sheets of an unsealed IGU assembly. According to various embodiments, one or more vacuum sources can include the holes 5962 in the first plate 5920 and/or the holes 5920 in the second plate 5922. In some cases the one or more vacuum sources includes a fluid handling device (not shown in FIG. 30) configured to evacuate an interpane space of the unsealed IGU assembly.

According to various embodiments, the holes 5962 in the first plate, the holes 5962 in the second plate 5922, and the fluid handling device each have a separate vacuum source. According to various embodiments, multiples vacuum sources are provided by separate and independent vacuum generators. According to various embodiments, multiple vacuum sources are provided by a single, larger vacuum generator that has separable zones, thus providing independent vacuums for each of the first plate 5920, the second plate 5922, and for the fluid handling device configured to evacuate the interpane space. In some cases providing independent vacuums provides greater control and stability of the relative pressures generated by, for example, the vacuum pulled by the first sheet 5920 on an outer sheet and the vacuum pulled within the IGU assembly during interpane evacuation.

FIG. 30 depicts one example of a vacuum generator 5902 (e.g., vacuum pump) that is part of the IGU gas filling system 5900 depicted in FIGS. 28-31. FIG. 30 also includes a partial view of ducting 5910 that connects and provides separate, selective fluid communication between the vacuum generator 5902 and the vacuum openings in the first plate 5920, the vacuum openings in the second plate 5922, and a fluid handling device used to fill and seal the second plate vacuum enclosure 5904.

As discussed above, various embodiments are directed to systems that are configured for evacuating and filling an unsealed IGU assembly without the use of a vacuum chamber or enclosure. In some cases, systems are configured to stabilize and secure an unsealed IGU assembly upon a support structure by pulling first and second vacuums on opposing outside sheets of the unsealed IGU assembly. In various embodiments, this additional support helps reduce and/or minimize the likelihood that the assembly's glass sheets will shatter when the IGU is evacuated and filled in an environment with an ambient air pressure approximately equal to atmospheric pressure.

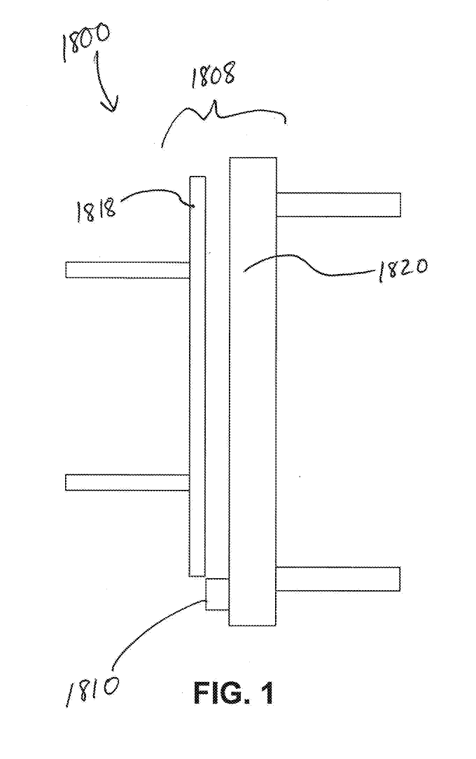

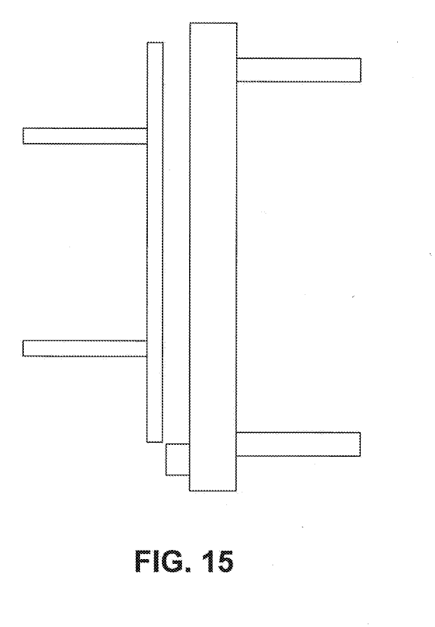

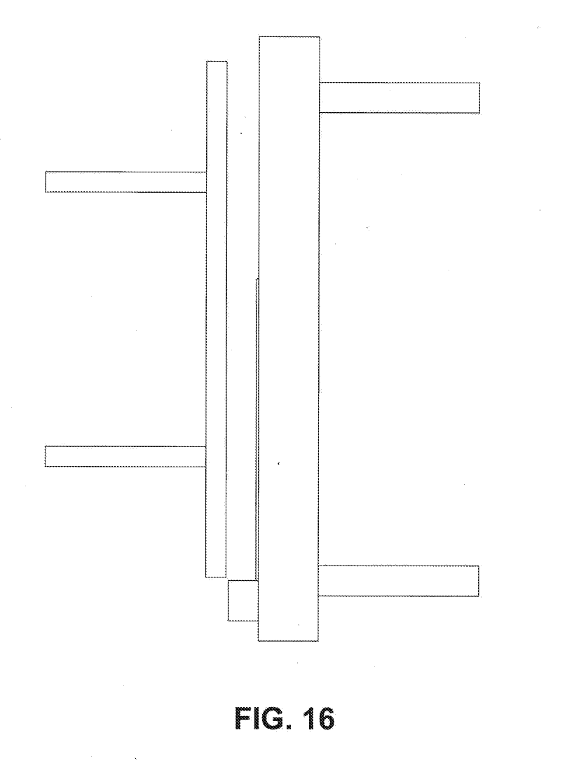

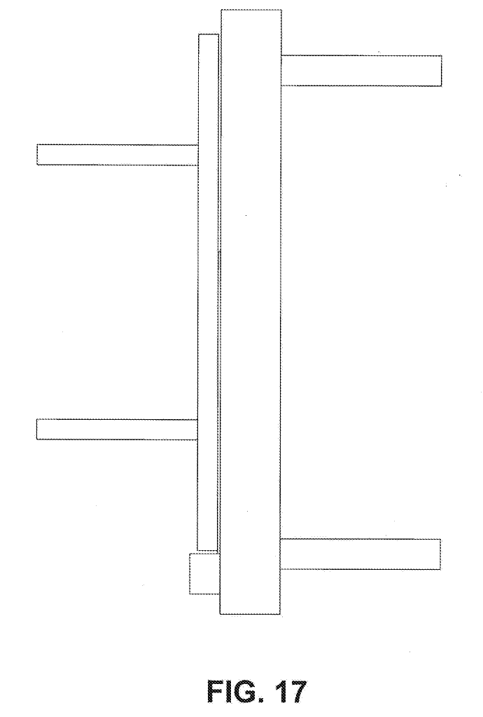

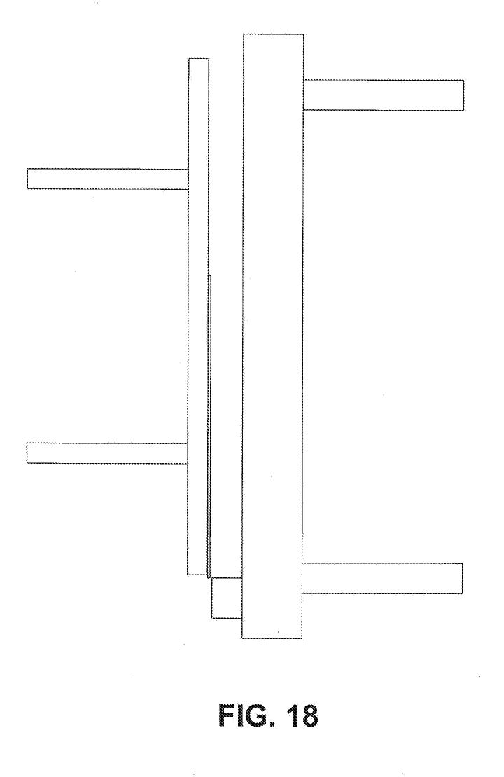

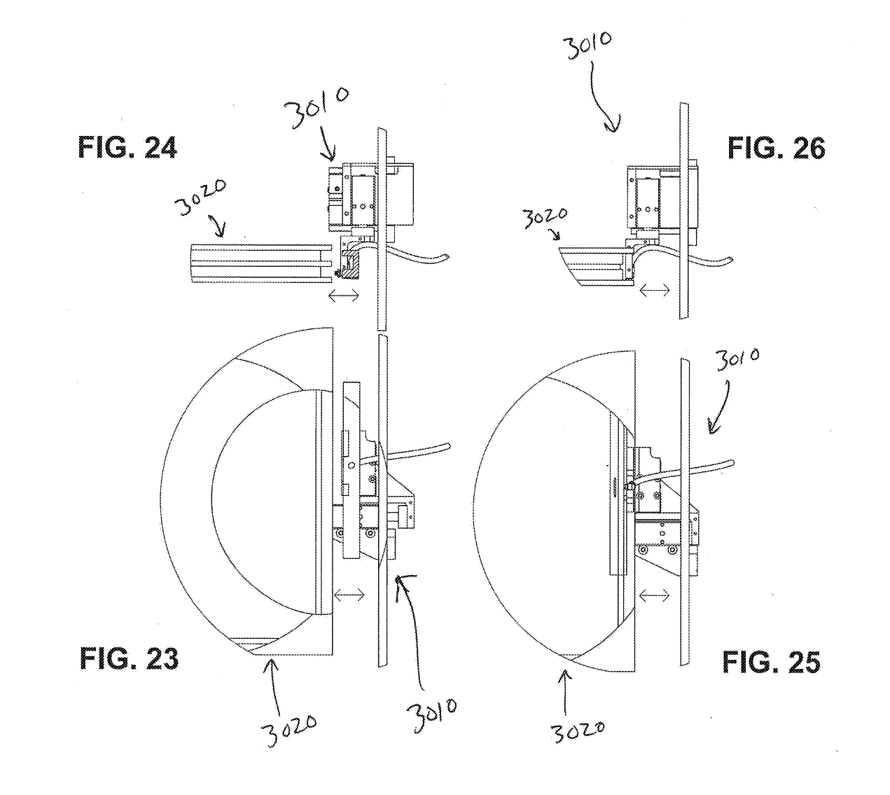

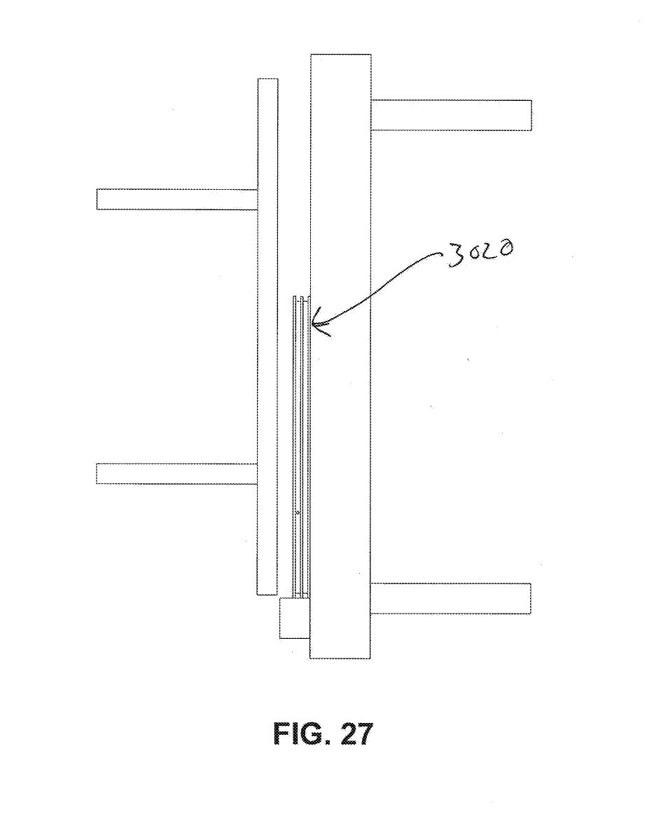

According to various embodiments, methods for manufacturing an insulating glass unit, including filling an IGU with an interpane gas, can include one or more of the aspects described above with respect to various systems for pulling a vacuum on the sheets. Turning to FIGS. 1-27, various views related to assembling, evacuating, filling, and/or sealing an unsealed IGU assembly are shown. FIGS. 1-14 depict, among other things, possible implementations in the context of double-pane IGUs. FIGS. 15-27 illustrate, among other things, possible implementations in the context of triple-pane IGUs. Of course it should be appreciated that the figures and corresponding descriptions are provided to illustrate aspects of various embodiments and that the teachings herein are not limited to the particularly illustrated embodiments of the figures.

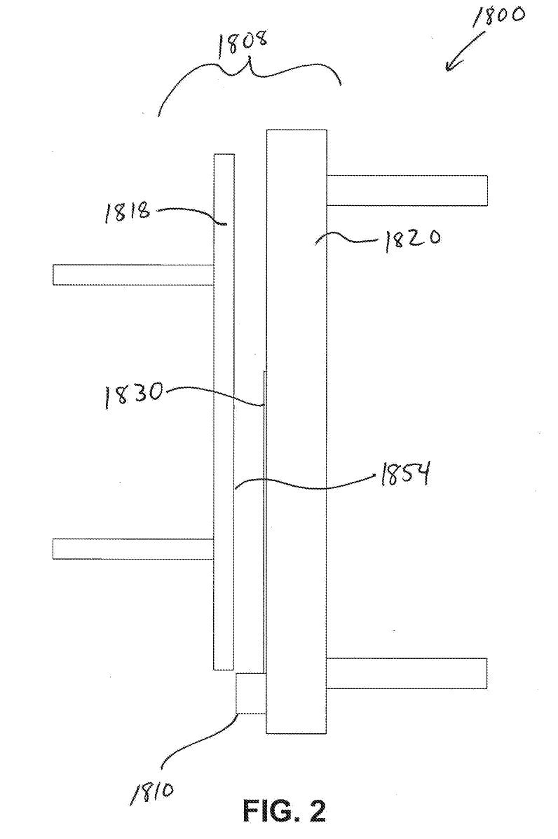

Turning now to FIG. 1, a side schematic view of a system 1800 for gas filling an unsealed insulated glass unit (IGU) assembly is illustrated according to various embodiments. The system 1800 includes a filling stage 1808 and a support structure 1810 for supporting an IGU as it is assembled, evacuated, and/or filled with an interpane gas. As shown in FIGS. 1-6, in some cases an unsealed IGU assembly is provided on the support structure 1810 by assembling various IGU components within the gas filling stage 1808 upon the support structure 1810. The filling stage 1808 is configured for receiving a first sheet 1830 of glass material upon the support structure 1810 as shown in FIG. 2.

One possible manner of providing the first sheet 1830 on the support structure 1810 includes conveying the first sheet into the filling stage 1808. As discussed elsewhere herein, in some cases the support structure includes one or more conveyors. In some cases the support structure is located adjacent to and/or attached to a support plate or back plate of the filling stage.

In the depicted implementation, the filling stage 1808 includes a first plate 1818 and a second plate 1820 that are configured to move relative to one another so as to close against the exterior surfaces of the first sheet 1830. According to various embodiments, the second plate 1820 is a fixed plate and the first plate 1818 is a movable plate. The support structure 1810 can be attached to the second plate 1820 and is configured to support the first sheet 1830. As an example, the filling stage illustrated in FIGS. 28-31 has a structure with opposing first and second plates 5920, 5922. In this case, one or more unsealed first sheets of glass material can be conveyed in a linear fashion from an initial assembly stage into an interior 5906 of the filling stage, as defined by the first and second plates. According to some embodiments, one plate is fixed and supports the first sheet with a support structure. The other plate then moves toward the fixed plate to press the first sheet of glass material and/or other components against the fixed plate. As discussed elsewhere herein, in various embodiments the fixed and movable plates are configured to pull a vacuum on an exterior surface of a sheet or assembly as it is being evacuated and/or filled within the filling stage.

Returning to FIG. 2, according to various embodiments, a sheet actuator moves the first sheet 1830 away from the support structure 1810 as part of forming an unsealed IGU assembly upon the support structure within the filling stage 1808. As an example, the first sheet 1830 can be moved away from the support structure after it is positioned on the support structure 1810, in order to make room for an IGU subassembly. In some implementations, the sheet actuator includes a mechanical and/or robotic actuator that secures the first sheet and then moves it away from the support structure. As shown in FIG. 2, in some cases the first plate 1818 provides the sheet actuator. According to various embodiments, the first plate 1818 is movably mounted within the filling stage 1808 and can be moved toward the first sheet 1830 to engage the first sheet and lift the sheet away from the support structure 1810.

As used herein, the first plate 1818 may in some cases be referred to as an assembly plate, and in some instances may be referred to as a movable plate, a platen, and/or a vacuum platen. In a similar way, the second plate 1820 may in some cases be referred to as a fixed plate, back plate, platen, and/or vacuum platen. It should be appreciated that the terms ‘first’ and ‘second’ are used for convenience only and that other modifiers like ‘fixed’, ‘movable’, ‘back’, ‘platen’, and ‘vacuum platen’ are used in the context of particular examples and are not necessarily meant to apply in all situations.

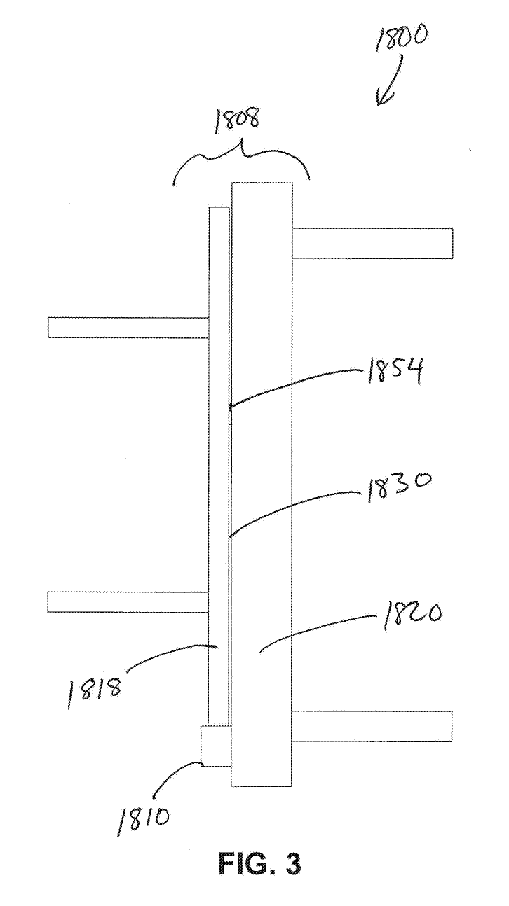

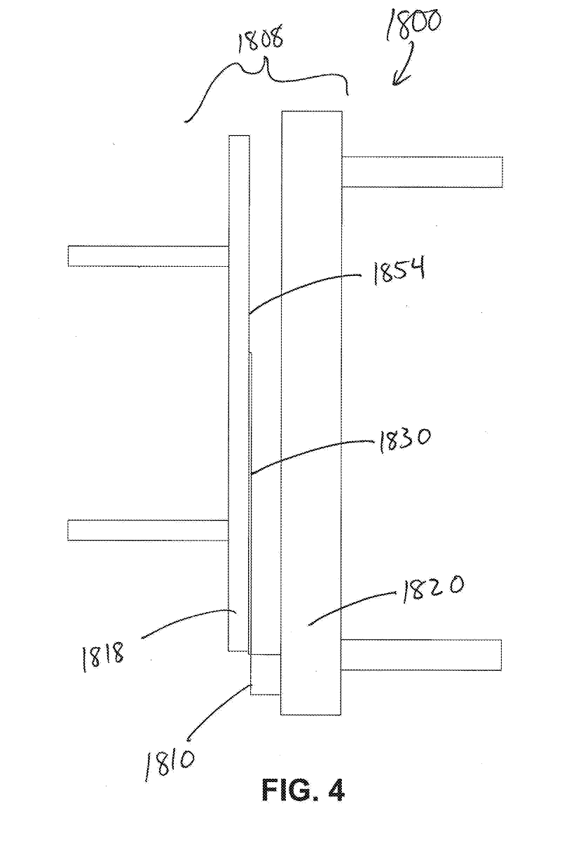

In some cases the first plate 1818 provides the functionality of a vacuum platen or optionally includes a separate vacuum platen. Turning to FIG. 3, when the first plate 1818 is positioned adjacent to the first sheet 1830, a vacuum is created at the surface 1854 of the first plate 1818 between the first plate 1818 and the first sheet 1830. In other words, the first plate pulls a vacuum on the first sheet 1830. The low pressure from the force of the vacuum allows the first plate 1818 to positively engage the first sheet 1830, thus holding the first sheet against the first plate 1818. According to various embodiments, the first plate 1818 then moves the first sheet away from the support structure 1810 as depicted in FIG. 4. In some cases, the first plate 1818 may initially lift the first sheet 1830 slightly above the support structure 1810 before moving the first sheet away from the support structure.

According to various embodiments, to create a vacuum at the surface 1854 of the first plate 1818, or with a separate vacuum platen, the first plate 1818 and/or the vacuum platen includes multiple openings in the surface 1854 of the plate that are in selective fluid communication with a vacuum source. As an example, FIGS. 28-31 depict a filling stage 5904 that includes a movable first plate 5920 and a fixed second plate 5922. As shown in FIG. 31 movable first plate 5920 is configured as a press plate. In addition, the first plate 5920 includes openings 5962 for generating a vacuum at the surface 5956 of the plate. The openings 5962 are in selective fluid communication with a vacuum source.

According to various embodiments, the amount of vacuum force used to engage the first sheet 1830 can vary as long as it is suitable for lifting the plate. In some implementations, a filling stage will include a vacuum generator that is used to evacuate an interpane space of an unsealed IGU assembly. In these cases, it can be sufficient to redirect the vacuum generator from evacuating the interpane space to pulling a vacuum through the first plate 1818.

In some cases, the vacuum source is the same vacuum source that is used for evacuating an interpane space of an unsealed IGU assembly. In some cases, a separate vacuum source can be used for generating the vacuum with the first plate 5920. As shown in FIG. 30, the system 5900 includes a vacuum generator 5902 that is in selective fluid communication with the system 5900 through ducting 5910.

According to some embodiments, the ducting 5910 selectively delivers the vacuum force from the generator 5902, e.g., via controllable switches and/or valves, to 1) a filling device probe for evacuating an interior of an unsealed IGU through the filling device, 2) the multiple openings 5962 in the face of the first plate 5920 depicted in FIG. 31, and/or 3) multiple openings 5962 in the face of the second plate 5922. According to various embodiments, as discussed above, each of the first plate 5920, the second plate 5922, and the filling or fluid handling device has a separate vacuum source. According to various embodiments, multiple vacuum sources are provided by separate and independent vacuum generators. In some embodiments, multiple vacuum sources are provided by a single, larger vacuum generator that has separable zones, thus providing independent vacuums for each of the first plate 5920, the second plate 5922, and for the fluid handling device configured to evacuate the interpane space.

According to various embodiments, the first plate 5920 in FIG. 31, as well as the first plate 1818 in FIG. 4, can pull a vacuum on the first sheet 1830. In some cases the first plate 1818 acts as a press plate, and thus pushes or presses the first sheet 1830 to seal it against an IGU subassembly as will be discussed. In some cases, the first plate 1818 is configured to apply the vacuum to the first sheet 1830 and to press the first sheet 1830 against an IGU subassembly as part of forming an unsealed IGU assembly. This configuration can be useful in that the first plate 1818 can function as both a vacuum platen and a press plate. As discussed elsewhere herein, according to various embodiments, the first plate 1818 can pull a vacuum upon the first sheet at the same time as pressing it (and the attached subassembly) in order to secure and stabilize the first sheet while the assembly's interpane space is evacuated.

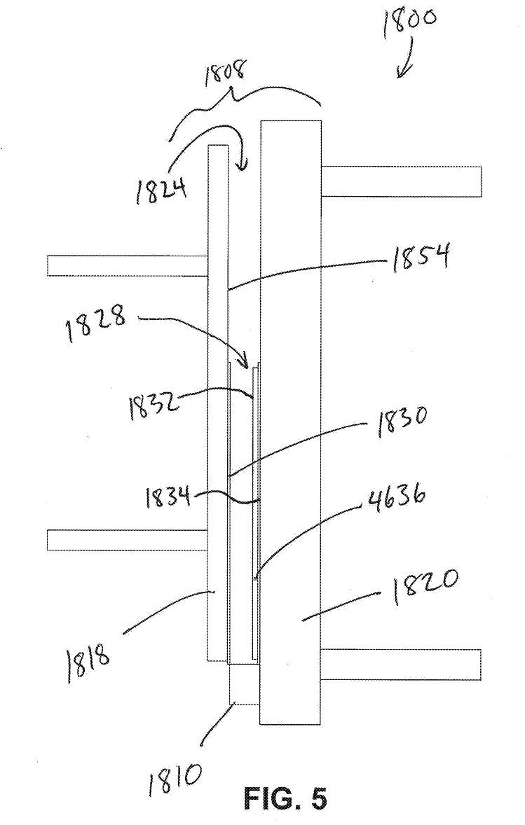

As shown in the figures, according to various embodiments, the first plate is movably mounted with respect to the filling stage. Although not shown in FIGS. 1-14, an actuating system, such as a system of drive motors and controls, is coupled to the first plate 1818 for moving the plate. In some implementations, moving the first sheet 1830 away from the support structure 1810 involves retracting the first sheet 1830 away from the fixed plate 1820 of the filling stage. In this type of implementation, the first plate 1818 first positively engages the first sheet 1830 and optionally lifts the sheet off of the support structure 1810 using, e.g., a vacuum. The first plate 1818 then moves away from the support structure 1810 as shown in FIGS. 4 and 5.

Turning to FIG. 5, moving the first sheet 1830 clears the support structure 1810, providing room for moving an IGU subassembly 1828 into the interior 1824 of the filling stage and onto the support structure 1810. As used herein, the term “IGU subassembly” refers to one, two, three, or more components of an IGU. According to various embodiments, the IGU subassembly 1828 includes a spacer frame 1832 attached or sealed to a second sheet of glass material 1834.

In some implementations, moving the IGU subassembly 1828 into the filling stage 1808 includes conveying the combination of the spacer 1832 and sheet 1834 into an interior 1824 of the filling stage and positioning the subassembly 1828 on the support structure 1810 of the filling stage 1808. As shown in FIG. 5, in some cases the IGU subassembly 1828 is placed on the support structure 1810 with the second sheet 1834 of glass material adjacent to the second plate 1820, with the spacer frame 1832 oriented out away from the second plate 1820, facing the first plate 1818.

As shown in FIG. 5 and in other figures, the first sheet 1830 and the IGU subassembly 1828 are separately moved onto the support structure 1810 adjacent to the second plate 1820 of the filling stage. In the illustrated examples, the support structure 1810 is depicted as a having a horizontal top surface that forms a right angle with the second plate, which is vertically-oriented. It is also possible to use different support structures, conveyors, back plates, and the like that support the first sheet and IGU subassembly at different orientations.

In some cases the support structure 1810 and the back second plate 1820 are tilted or angled with respect to horizontal and/or vertical orientations. As an example, the filling stage 5904 shown in FIGS. 28-31 includes a fixed plate 5922 in the form of an angled back plate and an attached, movable support structure 5942 such as a conveyor. FIG. 29 illustrates a tented, unsealed IGU assembly 6000 after assembly within the filling stage 5904. The unsealed IGU assembly 6000 includes a first sheet of glass material 6002 leaning against an IGU subassembly 6004 in a tented configuration. The IGU subassembly is formed from a spacer frame 6008 sealed against a second sheet 6006 of glass material.

According to various embodiments, the angle of the back plate 5922 is between about 5 degrees and about 10 degrees away from a vertical axis of the filling stage. The top surface of the support structure 5942 in this case forms a right angle with the back plate, but is angled with respect to a horizontal orientation due to the tilt of the back plate. In some cases the angle of the back plate is about 6 degrees, about 7 degrees, or about 6.5 degrees. Other suitable angles are also possible.

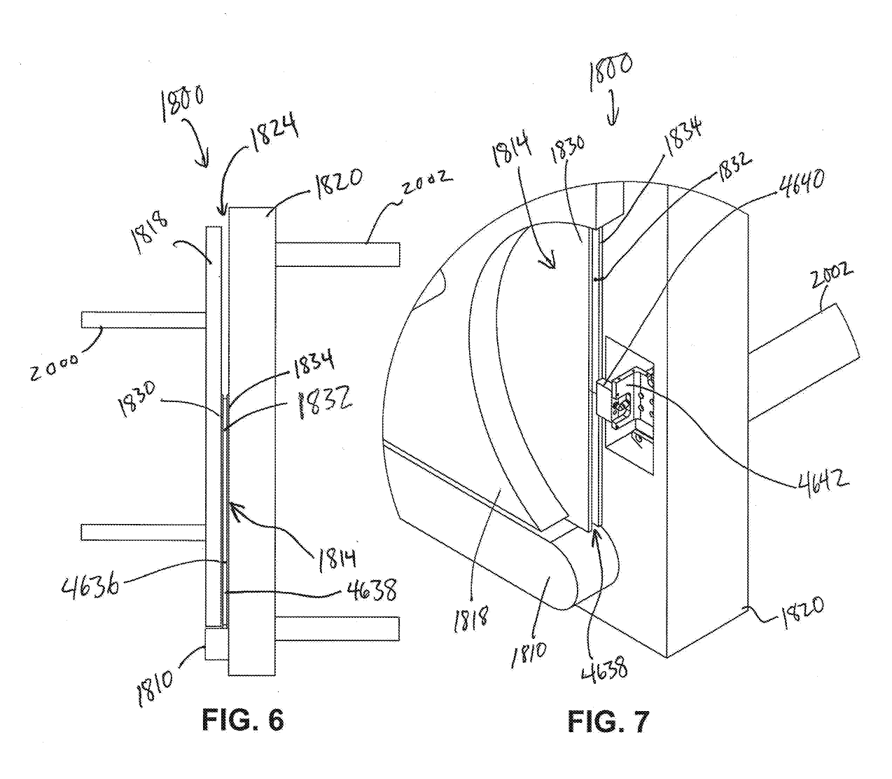

Referring to FIGS. 5 and 6, various embodiments include positioning the first sheet 1830, held by the first plate 1818, relative to the IGU subassembly 1828 located on the support structure 1810. In some cases the first plate 1818 moves the first sheet 1830 next to the IGU subassembly 1828 on the support structure 1810 as part of forming an unsealed IGU assembly 1814 within the interior 1824 of the filling stage.

According to some implementations, the first plate 1818 presses the first sheet 1830 against the IGU subassembly 1828 in order to seal the first sheet 1830 to the spacer frame 1832. According to some embodiments, a sealant or other adhesive is applied to the spacer frame 1832 before it enters the chamber. The sealant can thus hold the first sheet 1830 against the spacer frame 1832. According to various embodiments, the first plate 1818 directly presses the first sheet 1830 against the spacer frame 1832 of the IGU subassembly 1828 to form the unsealed IGU assembly 1814 as shown in the transition from FIG. 5 to FIG. 6 of the drawings.

Referring to FIG. 5, in some cases the first plate 1818 is configured to initially lean the first sheet 1830 against the spacer frame 1832 as part of forming a tented, unsealed IGU assembly. FIG. 29 illustrates one possible example of a tented IGU assembly 6000 positioned on the support structure 5942 within the filling stage 5904. Additional details about forming a tented IGU assembly upon a support structure are described in U.S. 62/528,082, and in the '11 application, the relevant portions of which are herein incorporated by reference.

FIG. 6 is a side schematic view of the filling system 1800 showing the assembled, unsealed IGU assembly 1814 positioned on the support structure 1810 within the interior 1824 of the filling stage 1808. The unsealed IGU assembly 1814 defines an IGU passage to the interpane space of the IGU through a hole 4636 in the spacer frame 1832, shown in FIG. 6. When the hole 4636 is referred to in the description of the FIGS., it is understood that the term IGU passage can be substituted for the term hole. According to the illustrated example, the unsealed IGU assembly 1814 defines an open channel 4638 formed between the first and second sheets 1830, 1834 and next to spacer frame 1832.

There are several different ways of providing the IGU passage for the unsealed IGU assembly 1814 on the support structure 1810 as shown in FIG. 6. The hole 4636 can be created in a spacer structure before or after it is formed into a spacer frame. The hole could be created before or after the spacer frame is attached to the first sheet. The hole could be created before or after the first and second sheets are sealed to the spacer frame. For each of these different points in the process of forming the unsealed IGU assembly, the hole could be created within the filling stage, before the IGU subassembly enters the filling stage, and before or after the unsealed IGU assembly is formed. The hole 4636 could be created with a drill, saw, knife, press or other implement.

In some examples, the hole 4636 has a diameter of at least about 0.040 inch, at least about 0.060 inch, at most about 0.25 inch, at most about 0.50, ranging from 0.060 to 0.25 inch, or about 0.125 inch.

As described elsewhere herein, the plates or platens of a gas filling stage are configured, according to various embodiments, to press together in order to secure an unsealed IGU assembly for evacuating the interpane space of the IGU assembly without the need for an enclosing vacuum chamber. According to some implementations, the plates are also configured to pull a vacuum on each of the outer sheets of the IGU assembly while pressing together. One example of this type of evacuation configuration is described in greater detail with respect to FIGS. 28-31. In that example, a first plate 5920 is used to press an IGU component against a second plate 5922, thus stabilizing and securing the IGU component. According to various embodiments, the first plate 5920 and/or the second plate 5922 are configured to pull a vacuum on an outer sheet of a supported IGU assembly to further secure and stabilize the IGU assembly during evacuation and filling without the use of a vacuum chamber.

Turning back to FIG. 6, in some implementations the first and second plates 1818, 1820 are configured as vacuum platens. For example, the first plate 1818 can include a fluid connection 2000 that provides selective fluid communication between vacuum openings on the face of the first plate and a vacuum source. Similarly, in some cases the second plate 1820 includes a fluid connection 2002 that provides selective fluid communication between vacuum openings on the face of the second plate and a vacuum source.

Before evacuation of the interpane space, the unsealed IGU assembly 1814 is pressed by the first plate or assembly plate 1818 assembly plate against the second plate 1820. The pressing action may be part of the process of forming the unsealed IGU assembly. According to some embodiments, evacuating the IGU assembly in an ambient atmospheric environment can cause the spacer 1832 to slip out of place, thus increasing the likelihood that one or more glass sheets will shatter. In some cases the force from pressing the IGU assembly against the second plate 1820 holds the spacer 1832 in position between the first and second sheets 1830, 1834.

According to some implementations, while pressing the unsealed IGU assembly 1814 against the second plate 1820, the gas filling system 1800 creates a first vacuum next to the first sheet 1830 and creates a second vacuum next to the second sheet 1834. In some cases, creating the first vacuum next to the first sheet 1830 is accomplished by evacuating air through openings in the face of the assembly or first plate 1818. Creating the second vacuum next to the second sheet 1834 can be accomplished in a similar manner by evacuating air through openings in the second plate 1820 as discussed elsewhere herein.

In contrast to evacuating and filling with a vacuum chamber, various embodiments provide a fluid handling device that can be used to evacuate and/or fill the interpane space of an unsealed IGU assembly. In some cases a fluid handling device can be used to evacuate and fill an IGU assembly in an ambient environment having an air pressure approximately equal to atmospheric pressure. FIGS. 7-13 illustrate a fluid handling device that can be used to evacuate and fill the interpane space of an unsealed IGU assembly according to various embodiments.

In some cases, a fluid handling device can define one, two, or more passages extending through the device for communicating with the IGU passage and/or interpane space of an unsealed IGU assembly. In some implementations one or more passages can be provided for evacuating air from the interpane space and pumping one or more gases into the interpane space of an unsealed IGU assembly. In some implementations, a passage may be provided for inserting a sealant into the IGU passage in order to close the IGU passage and seal the IGU. In some implementations a passage may be provided for inserting a sealant structure, such as a rivet, into an IGU passage such as a hole in the spacer.

According to various embodiments, a single passage can be used for communicating one, two, three, or more substances to and/or from the interpane space through the IGU passage. As an example, in some cases a fluid handling device may have a single passage that is used to evacuate an interpane space and also fill the interpane space with a gas. In such cases, the passage can be alternately coupled with correspondingly different sources, such as a vacuum generator and a gas source.

In some embodiments, a fluid handling device may have multiple passages that extend separately through the device. In some cases a device may have multiple passages that enter the device separately, but then converge into a single outlet for communication with the IGU passage. A variety of other configurations for the fluid handling device are possible in various embodiments, including the use of multiple device heads that optionally track together when the device is moved. According to some embodiments, the fluid handling device only includes one fluid passage that is used to evacuate air from the IGU assembly and also to fill the IGU assembly with an interpane gas.

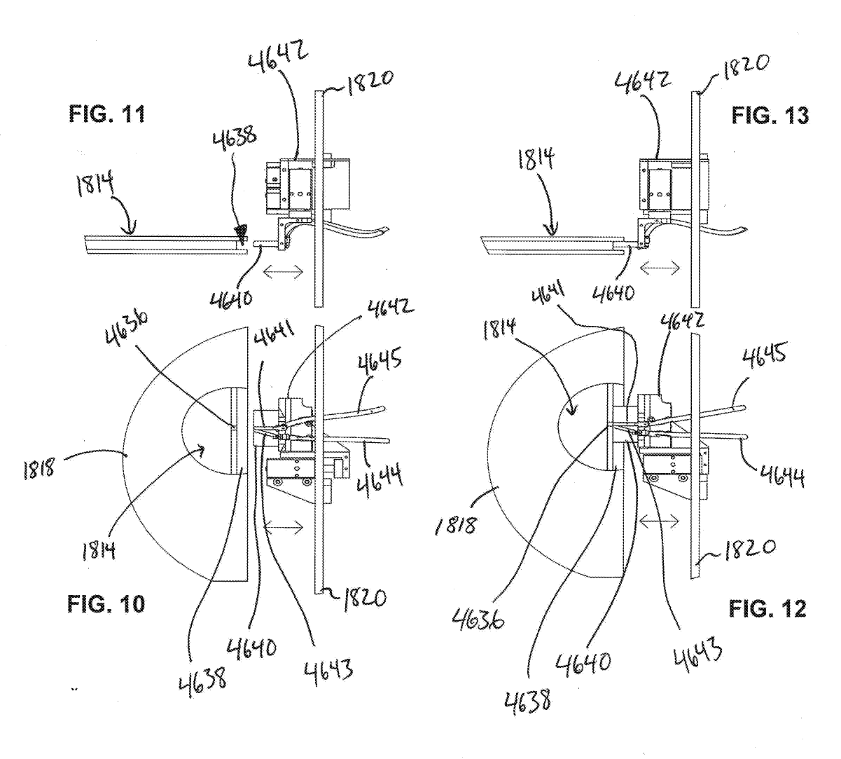

Turning back to the figures, FIG. 7 is a cut away perspective view of the system of FIG. 1 showing an actuator 4642 and a connected fluid handling device 4640 positioned next to the IGU passage 4636 of the unsealed IGU assembly 1814 depicted in FIG. 6. FIGS. 10-11 are partial front and top schematic views of the system of FIG. 7 showing the actuator 4642 and the connected fluid handling device 4640, according to various embodiments. FIGS. 10-11 show the fluid handling device 4640, actuator 4642, IGU 1814, and a side part of a first plate 1818 of the gas filling system 1800, with the fluid handling device positioned away from engagement with the IGU passage or hole in spacer frame.

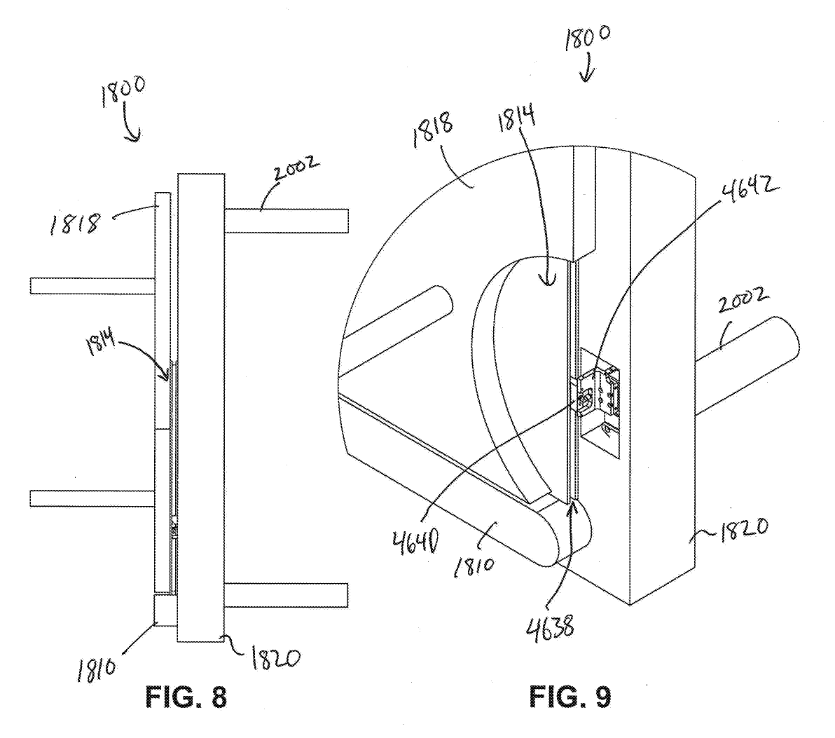

FIGS. 8-9 are side schematic and cut away perspective views, respectively, of the system 1800 of FIG. 7 showing the connected fluid handling device 4640 inserted into the IGU passage 4636 of the unsealed IGU assembly 1814, according to various embodiments. FIGS. 12-13 are partial front and top schematic views of the system of FIG. 8-9 showing the actuator 4642 and the connected fluid handling device 4640, according to various embodiments. FIGS. 12-13 show the same components as those shown in FIGS. 10-11, but with the fluid handling device contacting the spacer frame, so that the outlet of the fluid passages is in fluid communication with the hole in the spacer frame. The arrows indicate that the fluid handling device can be moved by the actuator toward or away from the IGU to bring the fluid handling device close to the hole in the spacer frame.

In the illustrated implementation, the fluid handling device 4640 defines a first fluid passage 4641 and a second fluid passage 4643 that exit from the device 4640 at a single outlet. The outlet can be positioned in the open channel 4638 of the IGU assembly 1814 so that the fluid passages 4641, 4643 mate with the IGU passage 4636 through the single outlet in the fluid handling device 4640.

According to various embodiments, one of the fluid passages 4641 can be used to evacuate the interpane space, and thus the passage 4641 is connected to a vacuum supply line 4645. In some cases, another passage 4643 is separately provided for inserting an interpane gas into the IGU passage 4643 and is correspondingly connected to a gas supply conduit 4644. The gas supply conduit 4644 is in fluid communication with a gas tank or other supply system of a first gas for filling the interpane space.

The fluid handling device 4640 is positioned within the open channel 4638 of the IGU assembly, so that the fluid passage is in fluid communication with the IGU passage. The fluid handling device 4640 is held by an actuator 4642 and is attached to the fixed, second plate 1820 as shown in the figures. In some cases, the fluid handling device and actuator may alternatively be attached to the first, moveable plate 1818 of the filling system 1800.

In some examples, a fluid handling device is substantially block-shaped. In some examples, the fluid handling device is cylindrical in shape. In some embodiments, the fluid handling device includes a planar sealing surface that defines an outlet of the fluid passage, so that the planar sealing surface will contact the spacer frame surface when the fluid handling device is in a first position to evacuate the interpane space or provide gas to the interpane space. In some examples, the fluid handling device includes a nozzle structure or conical structure that presses up to or into the hole 4636.

In various embodiments, the actuator 4642 is an automatic actuator. In various implementations, a control system for the actuator includes one or more of a processor, a motor and machine-readable instructions.

According to some embodiments, the fluid handling device includes a pressure transducer that measures the pressure in the interpane space when the fluid handling device is in contact with the spacer frame and when the fluid passage is in fluid communication with the IGU passage. The pressure transducer can be located within the fluid passage. In one embodiment, the fluid handling device defines a sensor passage, separate from the fluid passage, which can be brought into communication the IGU passage and can hold a pressure transducer or other sensor.

As discussed elsewhere herein, various embodiments provide the ability to evacuate and fill an interpane space of an IGU assembly without the need for using a vacuum chamber. As previously discussed, first and second plates of a filling system are configured to pull first and second vacuums on the exterior surfaces of the outer sheets of an unsealed IGU assembly.

According to various embodiments, while the first and second vacuums are maintained, and while the assembly sheet or first sheet is pressing the unsealed IGU assembly against second sheet, a fluid handling device can evacuate air from the interpane space. The fluid handling device is in communication with a vacuum source. The vacuum source can be configured to reduce the pressure of the existing gas in the interpane space to about 0.1 pounds per square inch absolute (psia). In various embodiments, the vacuum source can be configured to reduce the pressure in the interpane space to less than 0.1 psia, less than 0.2 psia, or less than 0.5 psia.

Evacuation of the interpane space will generally apply force to the spacer frame, urging it to move inward. The pressing of the unsealed IGU assembly between the first plate and second plate can counteract that inward force. Because of the force on the spacer frame during evacuation, it may be desirable to not evacuate the interpane space as fully as if the unsealed IGU were in a vacuum enclosure.

In various embodiments, a vacuum source is configured to pull a vacuum on the interpane space to at least about −7 pounds per square inch gauge (psig). In some cases, the vacuum source is configured to pull a vacuum on the interpane space to at least about −10 psig. In some cases, the vacuum source is configured to pull a vacuum to at least about −11 to −12 psig. In some cases, the vacuum source is configured to pull a vacuum to at least about −13 psig. In some cases, the vacuum source is configured to pull a vacuum to about −14 psig. In some cases, the vacuum source is configured to pull a vacuum to about −14 psig in about 15 seconds or less.

In some examples, the evacuation step removes about 50% of the air molecules from the interpane space before the interpane space is filled with a first gas. In those examples, the interpane space will have a composition of 50% of a first gas. Krypton is one example of a first gas. Argon is another example of a first gas. A Krypton-Argon gas blend is another example of a first gas.

As will be appreciated, the pressure within the interpane space will increase as the gas is introduced into the interpane space. According to some embodiments, the level of the first vacuum on the first sheet and the level of the second vacuum on the second sheet are gradually reduced as the pressure within the interpane space increases. In some examples, the pressure at an exterior surface of the first sheet and an exterior surface of the second sheet is within about 1 psig or within about 2 psig of the pressure in the interpane space. According to some embodiments, one or more pressure transducers are used to monitor the relative pressures of the interpane space and the exterior of the outer sheets.

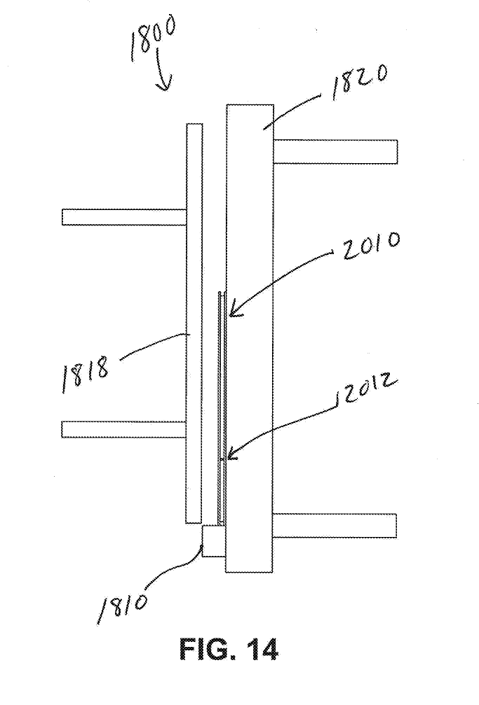

FIG. 14 is a side schematic view of the system 1800 of FIG. 4 showing an IGU 2010 after gas filling and sealing, according to various embodiments. As shown in the figure, the first and second plates 1818 and 1820 are opened and spaced apart, providing access to the completed, sealed IGU 2010 according to various embodiments.

According to various embodiments, the IGU passage has been closed with a sealant 2012, thus sealing the IGU's interpane space. In some cases the IGU passage may be closed and sealed while the IGU is still on the support structure. In some cases, the IGU passage may be closed before removing the first and second vacuums from the first and second sheets. According to various embodiments, the IGU passage may not be closed/sealed while the IGU is on the support structure. For example, in some cases an unsealed IGU can be evacuated and filled while on the support structure, and can then be removed from the support structure before closing the IGU passage to seal the unit.

As noted above, FIGS. 1-14 depict, among other things, possible implementations in the context of double-pane IGUs. FIGS. 15-27, which will now be discussed, are directed to various embodiments provided in the context of triple-pane IGUs.

According to various embodiments, an IGU subassembly for a triple pane IGU includes at least a second sheet of glass, an intermediate pane of a transparent or translucent material defining an opening, and at least one additional spacer frame sealed to the second sheet of glass and sealed to the intermediate pane. Some triple pane IGUs include a single spacer frame, and some include two spacer frames. The concepts described herein can apply to a double pane IGU assembly, a triple pane IGU assembly with a single spacer frame, and to a triple pane IGU assembly with two spacer frames. Where the term “the spacer frame” is used in this description, it can generally be replaced with “the at least one spacer frame” to apply to the context of a triple pane IGU with two spacer frames. U.S. Publ. No. 2017/0299121 provides additional details and teaching about assembling and filling a triple pane IGU, the relevant portion of which is herein incorporated by reference.

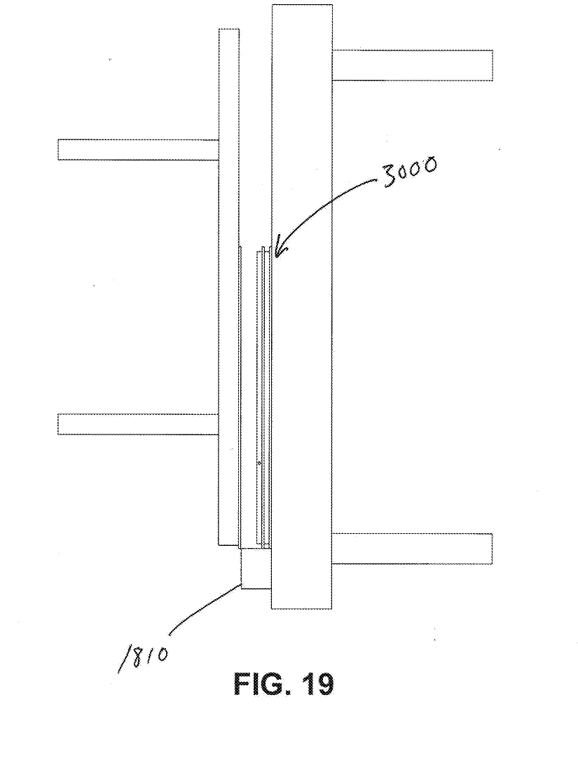

FIGS. 15-27 show steps in assembling, evacuating, filling, and/or sealing a triple pane IGU assembly according to various embodiments. The particular example for assembling a triple pane IGU assembly is similar to the process of assembling, evacuating, filling, and/or sealing the double pane IGU assembly illustrated in FIGS. 1-14, with the triple pane stage in FIG. 19 corresponding to the double pane stage in FIG. 5. According to various embodiments, the initial steps for forming an unsealed triple pane IGU assembly in FIGS. 15-18 are identical to the initial steps for forming an unsealed double pane IGU assembly in FIGS. 1-4.

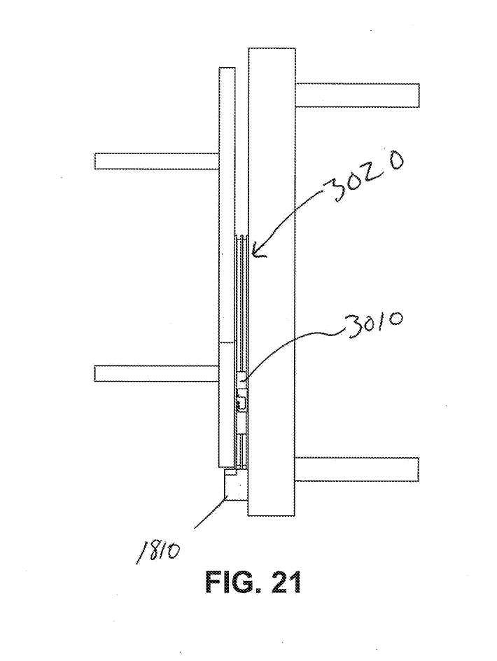

As shown in FIG. 5, in some cases a double pane IGU subassembly 1828 is placed on the support structure 1810 with the second sheet 1834 of glass material adjacent to the second plate 1820, with the spacer frame 1832 oriented out away from the second plate 1820, facing the first plate 1818. FIG. 19 illustrates an analogous step for the context of a triple pane IGU, in which a triple pane IGU subassembly 3000 is placed on the support structure 1810. FIG. 21 provides an illustration of the triple

In the example described with respect to FIGS. 5 and 6, the first plate 1818 moves the first sheet 1830 next to the IGU subassembly 1828 on the support structure 1810 as part of forming an unsealed IGU assembly. According to the embodiment depicted in FIGS. 19-21, the first plate 1818 similarly moves the first sheet 1830 next to the triple pane IGU subassembly 3000 on the support structure 1810 as part of forming the unsealed IGU assembly depicted in FIG. 21.

In accordance with various embodiments, the methods and mechanisms for assembling, evacuating, filling, and/or sealing a triple pane IGU—whether partially assembled and unsealed, assembled and unsealed with an IGU passage, or other configurations—are analogous to (e.g., similar to or the same as) the methods and mechanisms described herein with respect to other embodiments, with the exception that the triple pane IGU includes an additional spacer frame and sheet when compared to other examples of double pane IGUs described elsewhere herein.

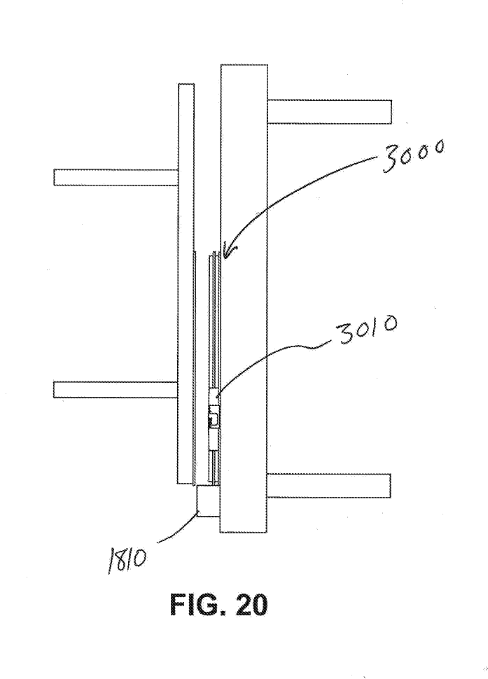

Aside from this difference, the example illustrated in FIGS. 20-27 also differs from the double pane example in that the filling device 3010 illustrated for the triple pane example has the form of a wedge filling block. For example, the unsealed triple pane IGU assembly 3020 shown in FIGS. 21-26 can be evacuated and/or filled with an interpane gas using a triple pane fluid handling device 3010 as illustrated. The device 3010 has the form of a wedge filling block similar in some respects to devices described elsewhere herein. The descriptions of those embodiments also describe similar features of the filling device 3010 as applicable. According to some embodiments, evacuating, filling and/or sealing the unsealed triple pane IGU assembly 3020 can be similar in some respects to evacuating, filling and/or sealing the examples of double pane IGUs described elsewhere herein. In addition, U.S. Publ. No. 2017/0299121 provides additional details and teachings about evacuating, filling and sealing a triple pane IGU, as well as relevant teachings about evacuating and/or filling with a wedge filling block. The relevant portions of U.S. Publ. No. 2017/0299121 are herein incorporated by reference.

As discussed in greater detail herein, moving a first sheet of glass material next to an IGU subassembly and forming an unsealed IGU assembly can be implemented in various ways. For example, in some cases an assembly plate positions the first sheet next to the IGU subassembly in a leaning or tent-like configuration (also referred to herein as a “tent” configuration) on the support structure within the vacuum enclosure. The gap between the first sheet and the IGU subassembly provides an IGU passage that provides fluid communication between the IGU's interpane space and the surrounding environment

In some cases, an assembly plate places the first sheet next to the IGU subassembly and then presses the first sheet against the IGU subassembly to seal at least part of the first sheet to at least part of the subassembly. In some cases an assembly plate presses the first sheet against the IGU subassembly to substantially seal the first sheet to the subassembly, while also leaving open an IGU passage that provides fluid communication into the IGU interpane space. Such implementations can involve a spacer frame or glass sheet with a hole or opening that provides the IGU passage. In some cases the IGU passage is provided by a filling block or optionally a wedge block that temporarily forms part of the seal between the first sheet and the IGU subassembly.

The illustrated examples discussed herein provide just one of many possible methods for assembling an unsealed IGU assembly that includes an IGU passage. As discussed, the method includes using a first plate, also referred to herein as an assembly plate, to move and assemble IGU assembly components within the filling stage. According to various embodiments, components such as glass sheets and IGU subassemblies can be positioned on a support structure for a filling stage in a variety of ways. For example, the components can be positioned on the filling stage support structure by hand, or may automatically advance into the filling stage along a linear conveyor system.

In some cases an unsealed IGU assembly can be formed in an assembly area and then placed on a conveyor leading to the filling stage. In some cases an unsealed IGU assembly can be formed in an assembly area and then be positioned at the filling stage by hand. In various embodiments, the unsealed IGU assembly is formed on an assembly stage conveyor that precedes the filling stage. The conveyor can then automatically move the unsealed IGU assembly onto the support structure of the filling stage in a translating or linear fashion.

Additional details regarding an IGU passage formed as a hole in a spacer frame are provided in U.S. 61/528,082 and the '11 application, both of which are herein incorporated by reference.

According to some embodiments, an unsealed IGU assembly can have an IGU passage in the form of an opening or hole in the assembly's spacer frame. An example of this type of IGU passage is shown in FIGS. 5 and 6. In those figures, the unsealed IGU assembly 1814 includes an opening or hole 4636 in the spacer frame 1832 of the IGU assembly. The IGU passage 4636 provides a fluid communication path between the interpane space and the surrounding ambient environment. As discussed elsewhere herein, the IGU passage can be used to evacuate the interpane space of the unsealed IGU assembly. In some cases the IGU passage can also or alternatively be used to fill the interpane space of the unsealed IGU assembly with one or more interpane gases.

According to various embodiments, an IGU passage of an unsealed IGU assembly can be formed in a number of different ways. In one example of an unsealed IGU assembly, an IGU passage to the interpane space is defined through an opening or hole in the spacer frame, where the sheets are both sealed to the spacer frame along a perimeter of the spacer frame. In some cases an IGU passage can be formed between a first sheet and the spacer frame, in the form of a wedge passage. Other types of IGU passages are also possible.

In yet another example of an unsealed IGU assembly, an IGU passage is defined through an opening or hole in the first or second sheet. The opening can be located close to an edge and/or corner of one of the first and second sheets. The spacer frame is sealed to both the first sheet and the second sheet around the entire spacer frame perimeter.

As illustrated in FIGS. 20-26, another example of forming an IGU passage includes a wedge-sealed IGU. In this case, a filling block, also referred to as a filling device, is positioned between the glass sheets outside of a perimeter of the spacer frame. The filling block causes a wedge passage to be defined between the spacer and one of the sheets. The filling block defines a filling block passage that is in fluid communication with the wedge passage. One example of such an embodiment is shown in FIGS. 28-29 of U.S. Publ. No. 2017/0299121. In various embodiments, including the embodiment of FIGS. 28-29 of U.S. Publ. No. 2017/0299121, the filling block is pressed against the spacer during the manufacturing process. In some examples, the face of the filling block that contacts the spacer includes a foam layer or other compressible material to improve the seal formed between the filling block and the spacer.

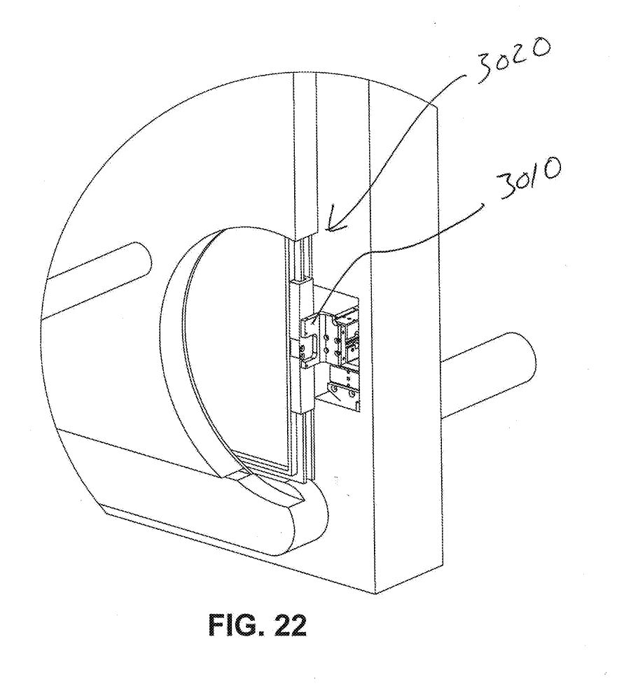

FIGS. 22-26 of U.S. Publ. No. 2017/0299121 illustrate an example of a filling device for forming a wedge-sealed IGU defining a wedge-passage. FIGS. 40-45 of the application illustrate another example of a filling device for forming a wedge-sealed IGU defining a wedge-passage.

These and other details and teachings about evacuating, filling and sealing a triple pane IGU, as well as relevant teachings about evacuating and/or filling with a wedge filling block can be applicable to the embodiments disclosed herein. The relevant portions of U.S. Publ. No. 2017/0299121 are herein incorporated by reference.

According to various embodiments, a method includes providing an unsealed IGU assembly on a support structure between a first plate and a second plate. The method further includes providing the unsealed IGU assembly on the support structure with the first sheet in a tented configuration with the spacer frame and the second sheet; positioning a wedge block between the first sheet and the second sheet outside a perimeter of the spacer frame, the wedge block defining a wedge block passage extending through the wedge block; and pressing the first sheet against the wedge block and the spacer frame with the first plate, thereby forming a wedge passage between the first sheet and the spacer frame. In addition, the wedge passage is in fluid communication with the wedge block passage. In some cases the first plate has a recess configured to reduce pressure on a portion of the first sheet that flexes outwardly about the wedge block.

According to some embodiments, an IGU passage includes a wedge passage between a first sheet and a spacer frame. A fluid handling device includes a wedge block having a wedge block passage extending through the wedge block. Further, automatically actuating the fluid handling device involves automatically positioning the wedge block between the first sheet and the second sheet outside a perimeter of the spacer frame so that the wedge passage is in fluid communication with the wedge block passage.

Various embodiments can include optional and/or other alternative features and aspects. For use with wedge-sealed IGU assemblies, in some examples the assembly or first plate has a recessed portion so that there is less force or no force placed upon the portion of the first sheet where it bulges around the filling device.

In some examples, an assembly or first plate is provided with a layer of foam or other conformable or cushioning material to reduce or more evenly spread the force placed on the glass sheet. For use with the wedge-sealed IGU assemblies, the cushioning or conformable material can reduce or more evenly spread the force placed on the glass where it flexes outwardly from the spacer around the filling device.

Further, when a hole in the first sheet of glass is used to define the IGU passage, the assembly plate can have a structure that accommodates the fluid handling device interfacing with the hole in the sheet. In some examples, the assembly plate does not cover the portion of the first sheet that defines the hole in the sheet. In some examples, a suction cup-like structure covers the hole in the sheet and provides the fluid communication to the fluid handling device.

Throughout the drawings and description, like reference numbers are used to refer to similar or identical parts.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference.

The technology has been described with reference to various specific and preferred embodiments and techniques. However, it should be understood that many variations and modifications may be made while remaining within the spirit and scope of the technology.

What is claimed is:

1. A method for filling an insulating glass unit (IGU) with a gas, comprising:
providing an unsealed IGU assembly on a support structure and between a first plate and a second plate, the unsealed IGU assembly comprising a first sheet, a second sheet, and a spacer frame between the first sheet and the second sheet, the unsealed IGU assembly defining an interpane space between the first sheet and the second sheet and an IGU passage providing fluid communication between the interpane space and an ambient environment;
pressing the unsealed IGU assembly against the second plate with the first plate while pulling a first vacuum on the first sheet with the first plate and pulling a second vacuum on the second sheet with the second plate;
evacuating air from the interpane space through the IGU passage; and
introducing a gas into the interpane space through the IGU passage.

2. The method of claim 1, wherein the ambient environment has an air pressure approximately equal to atmospheric pressure while evacuating the air from the interpane space and introducing the gas into the interpane space.

3. The method of claim 1, wherein pulling the first vacuum with the first plate comprises evacuating air through openings in the first plate and wherein pulling the second vacuum with the second plate comprises evacuating air through openings in the second plate.

4. The method of claim 1, wherein providing the unsealed IGU assembly on the support structure between the first plate and the second plate comprises forming the unsealed IGU assembly at an assembly stage and then moving the unsealed IGU assembly onto the support structure and into the space between the first plate and the second plate.

5. The method of claim 1, further comprising closing the IGU passage to seal the interpane space while the unsealed IGU assembly is on the support structure.

6. The method of claim 1, wherein providing the unsealed IGU assembly on the support structure between the first plate and the second plate comprises:
moving the first sheet to be on the support structure and between the first plate and the second plate;
moving the first sheet away from the support structure with the first plate;
moving an IGU subassembly to be on the support structure and between the first sheet and the second plate; and
moving the first sheet with the first plate to be next to the IGU subassembly to form the unsealed IGU assembly.

7. The method of claim 1, wherein evacuating the air from the interpane space comprises automatically actuating a fluid handling device to be in fluid communication with the IGU passage and evacuating the air through a fluid passage of the fluid handling device.

8. The method of claim 7, wherein the IGU passage comprises a hole in the spacer frame.

9. The method of claim 7, wherein introducing the gas into the interpane space comprises, after evacuating the air from the interpane space, introducing the gas into the interpane space through the fluid passage of the fluid handling device.

10. The method of claim 1, where the unsealed IGU assembly further comprises an intermediate pane of transparent or translucent material located between the first and second sheets, wherein the intermediate pane defines an opening to permit fluid communication between a first portion of the interpane space adjacent to the first sheet and a second portion of the interpane space adjacent to the second sheet.

11. A method for filling an insulating glass unit (IGU), comprising:
moving a first sheet to be on a support structure and between a first vacuum platen and a second vacuum platen;
moving the first sheet away from the support structure with the first vacuum platen;
moving an IGU subassembly to be on the support structure and between the first sheet and the second vacuum platen, the IGU subassembly comprising a spacer frame and a second sheet;
moving the first sheet next to the IGU subassembly with the first vacuum platen, and at least partially sealing the first sheet to the IGU subassembly, thereby forming an unsealed IGU assembly defining an interpane space between the first sheet and the second sheet and an IGU passage providing fluid communication between the interpane space and an ambient environment;
after forming the unsealed IGU assembly, pulling a first vacuum on the first sheet with the first vacuum platen and pulling a second vacuum on the second sheet with the second vacuum platen; and
while pulling the first vacuum on the first sheet and the second vacuum on the second sheet, pressing the unsealed IGU assembly against the second vacuum platen with the first vacuum platen,
evacuating air from the interpane space through the IGU passage, and
introducing a gas into the interpane space through the IGU passage.

12. The method of claim 11, wherein the ambient environment has an air pressure approximately equal to atmospheric pressure while evacuating the air from the interpane space and introducing the gas into the interpane space.

13. The method of claim 11, wherein evacuating the air from the interpane space comprises automatically actuating a fluid handling device to be in fluid communication with the IGU passage and evacuating the air through a fluid passage of the fluid handling device.

14. The method of claim 13, wherein the IGU passage comprises a hole in the spacer frame.

15. The method of claim 13, wherein introducing the gas into the interpane space comprises, after evacuating the air from the interpane space, introducing the gas into the interpane space through the fluid passage of the fluid handling device.

16. The method of claim 11, where the unsealed IGU assembly further comprises an intermediate pane of transparent or translucent material located between the first and second sheets, wherein the intermediate pane defines an opening to permit fluid communication between a first portion of the interpane space adjacent to the first sheet and a second portion of the interpane space adjacent to the second sheet.

17. A system for gas filling of an insulated glass unit (IGU), the system comprising:
a support structure configured to support an unsealed IGU assembly during evacuation and filling with a gas, the unsealed IGU assembly comprising an outer first sheet, an outer second sheet, and a spacer frame between the first sheet and the second sheet, the unsealed IGU assembly defining an interpane space between the first sheet and the second sheet and an IGU passage providing fluid communication between the interpane space and an ambient environment;
a first plate configured to pull a first vacuum on the first sheet of the unsealed IGU assembly upon the support structure;
a second plate attached to the support structure and facing the first plate, the second plate configured to pull a second vacuum on the second sheet of the unsealed IGU assembly upon the support structure;
a fluid handling device configured to be positioned next to the IGU passage of the unsealed IGU assembly upon the support structure for one or more of evacuating the interpane space and filling the interpane space with the gas;
a vacuum source in selective fluid communication with one or more of the first plate, the second plate, and the fluid handling device; and
a gas supply in selective fluid communication with the fluid handling device;
wherein the first plate is configured to simultaneously press the unsealed IGU assembly against the second plate and pull the first vacuum on the first sheet while the second plate pulls the second vacuum on the second sheet, to assist the fluid handling device in evacuating the interpane space of the unsealed IGU assembly while in an ambient environment having an air pressure approximately equal to atmospheric pressure.

18. The system of claim 17, wherein the first sheet comprises a first vacuum platen and the second sheet comprises a second vacuum platen.

19. The system of claim 17, wherein the IGU passage comprises a hole in the spacer frame of the unsealed IGU assembly, wherein the fluid handling device comprises a fluid passage in selective fluid communication with the vacuum source, and further comprising an actuator configured to automatically move the filling device into a first position where the fluid passage is in fluid communication with the IGU passage to evacuate the interpane space.

20. The system of claim 19, wherein the fluid passage of the fluid handling device is in selective fluid communication with the gas supply for inserting the gas into the interpane space of the unsealed IGU assembly after evacuation.

21. The system of claim 17, wherein the support structure is configured to receive the first sheet and wherein the first plate is further configured to
pick up the first sheet from the support structure,
move the first sheet away from the support structure, and
place the first sheet back on the support structure next to an IGU subassembly to form the unsealed IGU assembly.
